(19) United States
(12) Patent Application Publication
(10) Pub. No.: US 2025/0110691 A1
(43) Pub. Date: Apr. 3, 2025

(54) Intelligent Control Interface for Multi-Purpose Playback Device

(71) Applicant: Sonos, Inc., Goleta, CA (US)

(72) Inventors: Jonas Konrad Grim, Berghaupten (DE); Philippe Vossel, Berlin (DE)

(21) Appl. No.: 18/899,341

(22) Filed: Sep. 27, 2024

Related U.S. Application Data
(60) Provisional application No. 63/586,191, filed on Sep. 28, 2023.

(51) Int. Cl. G06F 3/16; H05B 47/175

(52) U.S. Cl. CPC G06F 3/165; H05B 47/196

(57) ABSTRACT

An intelligent control interface of a playback device comprises logical regions each corresponding to a respective setting of the playback device. A set of inputs initiated at a location in a given region of the control interface can be used to adjust a given setting of the playback device. The playback device may detect a first set of user inputs including a first drag input initiated at a first location on the control interface; based on the first location, determine a first command to adjust a first setting; and based on the first drag input, adjust the first setting. The playback device may detect a second set of user inputs including a second drag input initiated at a second location on the control interface; based on the second location, determine a second command to adjust a second setting; and based on the second drag input, adjust the second setting.

### CROSS-REFERENCE TO RELATED APPLICATIONS

This application claims priority to U.S. Provisional Application No. 63/586,191, filed Sep. 28, 2023, and titled “Intelligent Control Interface for Multi-Purpose Playback Device,” the contents of which are incorporated by reference herein in their entirety.

### FIELD OF THE DISCLOSURE

This disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, titled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), a listener can play desired media content in any environment having a networked playback device. In a multi-room environment, media content (e.g., songs, podcasts, audiobooks, audio corresponding to video content, etc.) can be streamed to playback devices such that different media content can be played back in each room having at least one playback device. Further, playback devices in different rooms can be grouped together for synchronous playback of media content such that the same media content can be played back in synchrony in two or more rooms, thereby enabling a listener to experience synchronous playback of the same media content from different rooms and/or while moving between rooms.

Given the ever-growing interest in digital media and increased consumer expectations and demands for enhanced playback experiences, there continues to be a need to develop consumer-accessible technologies to further enhance the listening experience.

### BRIEF DESCRIPTION OF THE DRAWINGS

FIG. 1A is a partial cutaway view of an environment having a media playback system configured in accordance with aspects of the disclosed technology.

FIG. 1B is a schematic diagram of the media playback system of FIG. 1A and one or more networks.

FIGS. 1C through 1E are block diagrams of example playback devices.

FIG. 1F is a block diagram of an example network microphone device.

FIG. 1G is a block diagram of an example playback device.

FIG. 1H is a partially schematic diagram of an example control device.

FIG. 1I is a schematic diagram of example user interfaces of the example control device of FIG. 1H.

FIGS. 1J through 1M are schematic diagrams of example corresponding media playback system zones.

FIG. 1N is a schematic diagram of example media playback system areas.

FIG. 2 is a diagram of an example headset assembly for an example playback device.

FIG. 3 is an isometric diagram of an example playback device housing.

FIG. 4A depicts an example of a capacitive control element according to a first embodiment of the disclosed technology.

FIG. 4B depicts a diagram of the capacitive control element of FIG. 4A integrated with a playback device according to one embodiment of the disclosed technology.

FIGS. 5A, 5B, and 5C illustrate example user input commands provided at the capacitive control element of FIG. 4 according to one embodiment of the disclosed technology.

FIG. 6 depicts an example of a capacitive control element according to a second embodiment of the disclosed technology.

FIG. 7 depicts an example of a capacitive control element according to a third embodiment of the disclosed technology.

FIG. 8 depicts an example of a capacitive control element according to a fourth embodiment of the disclosed technology.

FIG. 9 depicts an example of a capacitive control element according to a fifth embodiment of the disclosed technology.

FIG. 10 depicts a flow diagram showing example operations that may be carried out during a process for adjusting playback device settings according in accordance with aspects of the disclosed technology.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

As technology related to media playback experiences continues to develop, the demands and expectations of modern listeners (e.g., users) also continue to evolve. For instance, modern users expect to manage the media playback devices in their networked media playback systems in a convenient and accessible way. While access to such customization and control options is typically available by accessing a separate control device, such as a smartphone that is installed with a software application for controlling playback devices in a media playback system, relying solely on a control device to access control options is not always convenient or practical. In this respect, on-product user interfaces can provide an alternative means for easily and conveniently controlling playback device behavior.

However, conventional hardware-based user interfaces on playback devices in a networked media playback system have provided relatively limited capabilities that are focused on simple, commonly-used controls for manipulating playback, such as volume controls (e.g., volume buttons or a volume dial), and transport controls (e.g., a play/pause button, skip forward/backward buttons). Other more advanced functionalities of the playback device, such as forming groups with other playback devices for synchronous playback, controlling the volume of other playback devices in a synchrony group, adjusting equalization settings, changing input sources, etc., are generally accessed via a control device. Further, the selection of content for playback (e.g., a given audio track, playlist, radio station, etc., from a given media content source) and the initiation of playback is typically carried out via the control device as well, or perhaps by a voice assistant service if the playback device supports such a service and the user has elected to use one.

SONOS, Inc. (“Sonos”), who is the Assignee of the present application, has been an innovator in the area of hardware-based on-product user interfaces. For example, Sonos has developed new technology for grouping different playback devices for synchronous playback of media content based on interacting with a user interface of a first playback device (e.g., by pressing a button on the first playback device, etc.), more information about which can be found in U.S. Pat. No. 10,209,947, filed Jul. 23, 2014, and entitled “Device Grouping,” the contents of which are incorporated by reference herein in their entirety.

As another example, Sonos has developed new technology for controlling a particular aspect of media playback based on interacting with a user interface of a playback device in a particular way (e.g., providing a “swipe” input to skip a track, etc.), more information about which can be found in U.S. Pat. No. 9,671,780, filed Sep. 29, 2014, and entitled “Playback Device Control,” the contents of which are incorporated by reference herein in their entirety.

As yet another example, Sonos has developed new technology for transitioning media playback between playback devices based on interacting with a user interface of a playback device, more information about which can be found in U.S. Pat. Pub. 2020/0401365, filed Aug. 31, 2020, and entitled “Ultrasonic Transmission for Presence Detection,” the contents of which are incorporated by reference herein in their entirety.

Further, as another example, Sonos has developed new technology for personalizing listening experiences using different operational modes and dedicated playback controls, more information about which can be found in U.S. Pat. Pub. 2022/0286795, filed Mar. 8, 2022, and entitled “Operation Modes, Audio Layering, and Dedicated Controls for Targeted Audio Experiences,” the contents of which are hereby incorporated by reference in their entirety.

Further yet, as another example, Sonos has developed new technology for controlling sound and light behavior to create immersive audiovisual playback experiences based on sound and light production, more information about which can be found in U.S. Pat. Pub. 2023/0007752, filed Jul. 1, 2022, and entitled “Sound and Light Experiences,” the contents of which are hereby incorporated by reference in their entirety.

Further still, as another example, Sonos has developed new technology for controlling media playback experiences using hardware-based shortcut controls, more information about which can be found in U.S. Pat. Pub. 2023/0096397, filed Sep. 30, 2022, and entitled “Intelligent User Interfaces for Playback Devices,” the contents of which are hereby incorporated by reference in their entirety.

Nonetheless, there are some drawbacks associated with the hardware-based user interfaces discussed above. For instance, in situations where certain playback device controls are available via a hardware-based user interface through a specific control input (e.g., a long-press on a particular button, a swipe across a playback device surface, etc.), some users may not be aware of the specific control input required to access such controls. Even in situations where playback device controls are accessible via a voice assistant service, voice command processing can be, or can seem to the user to be, unreliable or inaccurate, and moreover, it is possible that a playback device's voice assistance service is configured to recognize only certain users, all of which may lead to user frustration as a result of limited ability to control the behavior of the playback device.

Further, existing hardware-based user interfaces do not provide a means for flexibly controlling different aspects of multi-purpose devices. For instance, media playback today has become such a ubiquitous feature of user environments (e.g., homes, offices, etc.) that media playback devices are being integrated with other devices and/or device functionalities to provide users with multi-purpose devices (e.g., Internet of Things (IoT) devices such as lamps, picture frames, bookshelves, wireless routers, etc.) that enable functionality in addition to playback of media content. For example, Sonos has co-developed multi-purpose playback devices that are capable of producing both sound and light. As with media playback devices, modern users expect to be able to manage the various functionalities of such multi-purpose devices in a convenient and accessible manner. However, controls for managing different aspects (e.g., sound and light production) of such a playback device are typically accessible only via a user interface of a separate control device. Moreover, in many instances, users may be required to access separate respective user interfaces for controlling sound behavior and light behavior of a playback device, which can be tedious and frustrating.

To illustrate with a practical example, a user of a multi-purpose playback device having both sound and light functionalities may wish to adjust different aspects (i.e., different settings) of the playback device. For instance, the user may wish to adjust a sound setting, such as a volume level, and/or a light setting, such as a brightness level, of the playback device. Typically, the user would need to access a user interface displayed at a controller device (e.g., a smartphone, a tablet, etc.) in order to make such adjustments. Moreover, the user would typically need to access different user interfaces to adjust each of the sound and light settings, which may involve downloading and then accessing separate applications (e.g., mobile applications) dedicated to controlling each of the sound settings and the light settings. However, being required to rely on a controller device for each desired adjustment to the playback device can be cumbersome and inconvenient. For instance, the user may wish to make several adjustments to the sound or light settings in a given period of time and may become frustrated at having to access a controller device, open a respective application for adjusting a sound or a light setting, and then providing an input to adjust the setting each time an adjustment is desired. In some instances, the user may not have convenient access to a controller device at the time when an adjustment is desired. Further, some users in a user environment with a media playback system (e.g., guest users, non-primary users, etc.) may not have access to a control device, and thus their ability to access certain playback device controls (e.g., adjust volume, select content for playback, group devices for synchronous playback, etc.) that would typically be available via a user interface of the control device is limited.

Building upon its innovations in the area of hardware-based user interfaces, Sonos has developed new technology for controlling different aspects of a playback device having multiple functionalities (e.g., a playback device having both sound and light functionalities).

Advantageously, the disclosed control interface enables control of multiple different settings (e.g., a volume setting, a brightness setting, a media playback setting, media content selection, etc.) of a playback device via a single control interface that is conveniently accessible on an external surface of the playback device. Further, the disclosed control interface alleviates user reliance on a separate controller device to access one or more user interfaces for controlling the different aspects of the playback device. Notably, the disclosed control interface may be configured so as to take up minimal real estate on a surface of a playback device while providing necessary control options for controlling the different aspects of the playback device.

In practice, the disclosed intelligent control interface may be integrated with a multi-purpose playback device. The disclosed control interface may take various forms, as will be discussed in detail further below. For example, in one embodiment, the control interface may take the form of a capacitive control strip that comprises a dedicated region corresponding to each setting of the playback device that is available for adjustment via the control strip.

Accordingly, in one aspect, disclosed herein is a method for adjusting two or more settings of a playback device, wherein the method involves: (i) detecting a first set of user inputs initiated at a first location on a capacitive control strip of a computing device, the first set of inputs including a first drag input on the capacitive control strip, (ii) based on the first location on the capacitive control strip, determining a first command to adjust a first setting of the computing device, (iii) based on the determined first command and the first drag input, causing the first setting of the computing device to be adjusted, (iv) detecting a second set of user inputs initiated at a second location on the capacitive control strip, the second set of inputs including a second drag input on the capacitive control strip, (v) based on the second location on the capacitive control strip, determining a second command to adjust a second setting of the computing device, wherein the second setting is different from the first setting, (vi) and based on the determined second command and the second drag input, causing the second setting of the computing device to be adjusted. In some implementations, the method may further involve (vii) causing respective first settings of one or more additional playback devices to be adjusted based on the first command and the first drag input and (viii) causing respective second settings of the one or more additional playback devices to be adjusted based on the second command and the second drag input.

In another aspect, disclosed herein is at least one non-transitory computer-readable medium, wherein the at least one non-transitory computer-readable medium is provisioned with program instructions that, when executed by at least one processor, cause a playback device to perform any one or more of the functions disclosed herein, including any functions of the foregoing method.

In yet another aspect, disclosed herein is a playback device comprising at least one processor, non-transitory computer-readable medium, and program instructions stored on the non-transitory computer-readable medium that are executable by at least one processor such that the playback device is configured to perform any one or more of the functions disclosed herein, including any functions of the foregoing method.

It will be understood by one of ordinary skill in the art that this disclosure includes numerous other embodiments. It will be understood by one of ordinary skill in the art that this disclosure includes numerous other examples. While some examples described herein may refer to functions performed by given actors such as “users” and/or other entities, it should be understood that this description is for purposes of explanation only. The claims should not be interpreted to require action by any such example actor unless explicitly required by the language of the claims themselves.

Further, while some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

### II. Suitable Operating Environment

a. Suitable Media Playback System

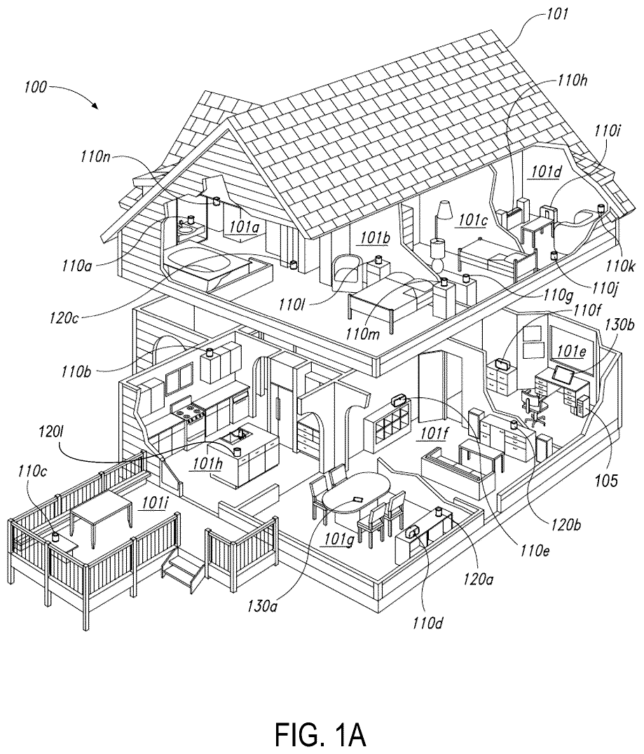

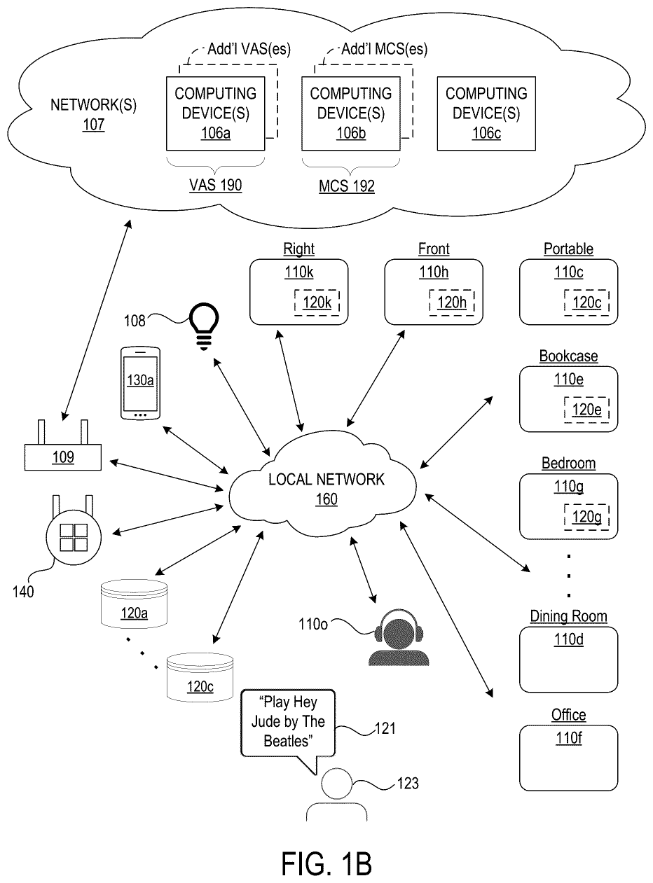

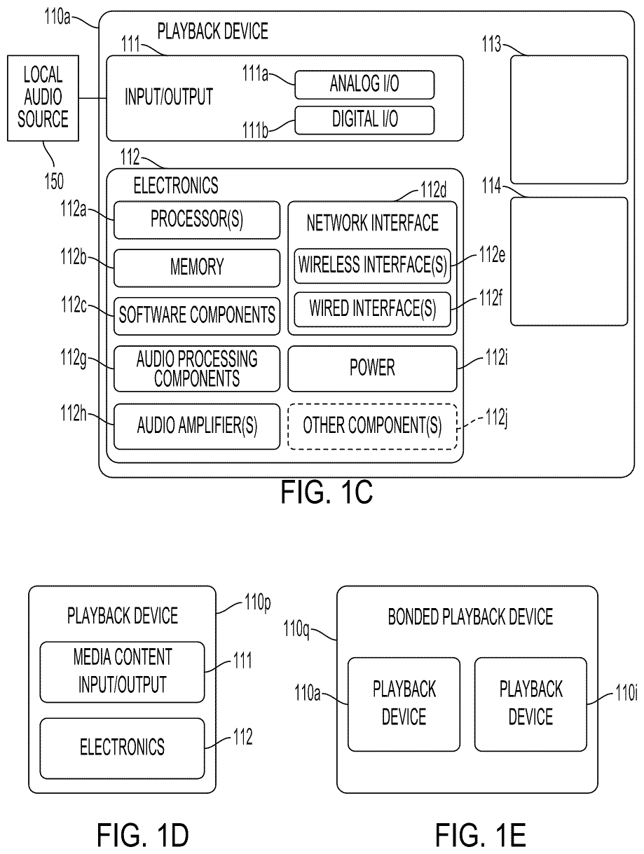

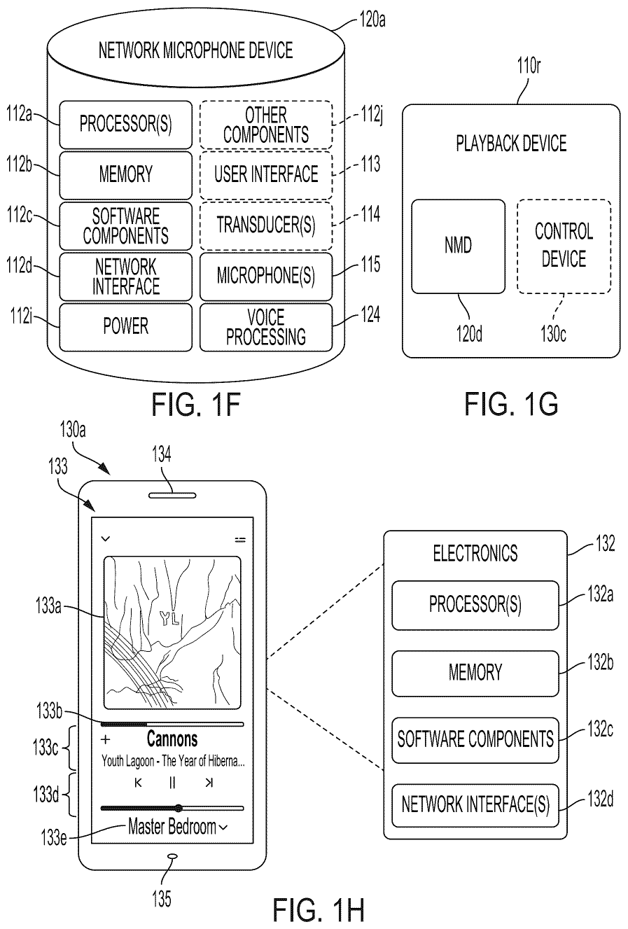

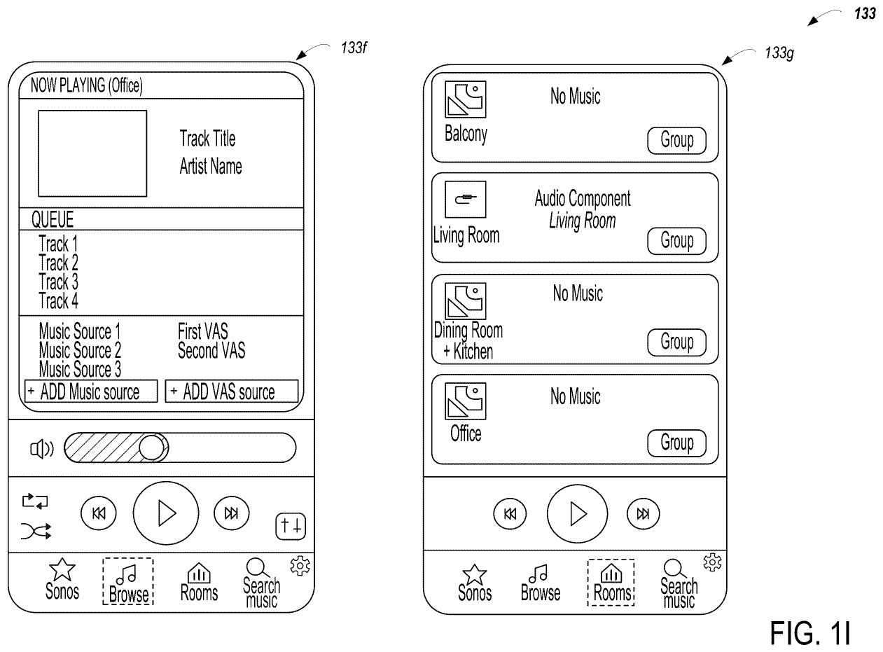

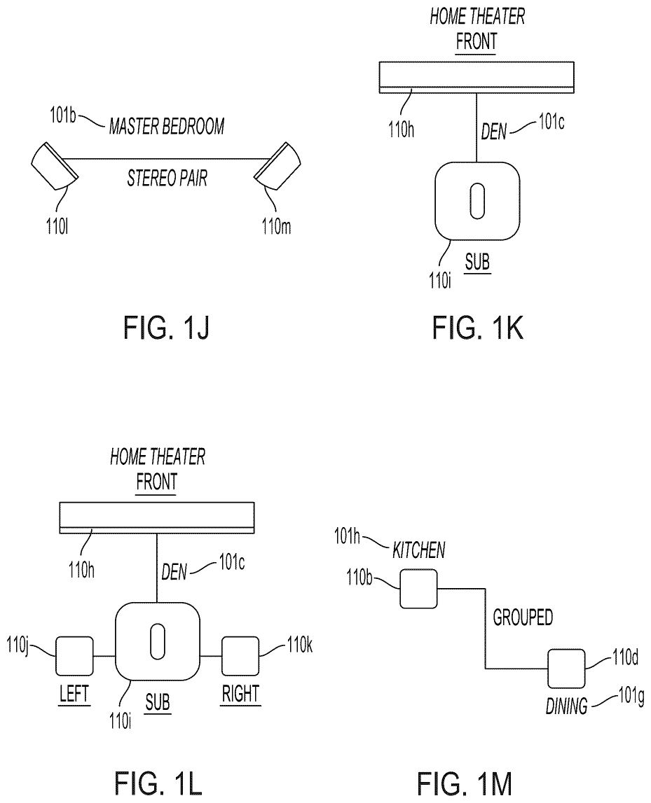

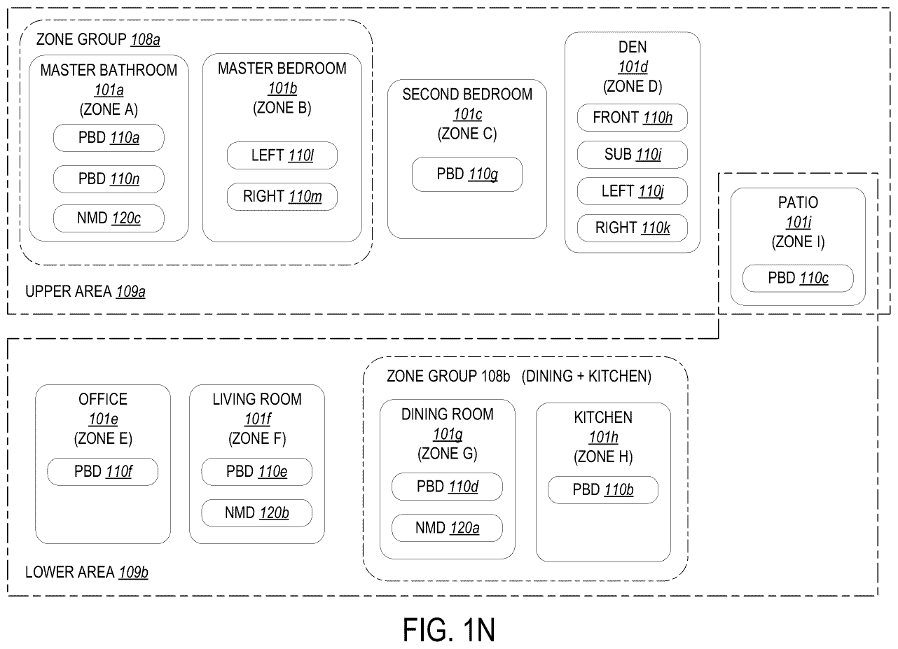

FIGS. 1A and 1B illustrate an example configuration of a media playback system (“MPS”) 100 in which one or more embodiments disclosed herein may be implemented. Referring first to FIG. 1A, a partial cutaway view of MPS 100 distributed in an environment 101 (e.g., a house) is shown. The MPS 100 as shown is associated with an example home environment having a plurality of rooms and spaces. The MPS 100 comprises one or more playback devices 110 (identified individually as playback devices 110a-o), one or more network microphone devices (“NMDs”) 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the MPS 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the MPS 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the MPS 100 is configured to play back audio from a first playback device (e.g., the playback device 110a) in synchrony with a second playback device (e.g., the playback device 110b). Interactions between the playback devices 110, NMDs 120, and/or control devices 130 of the MPS 100 configured in accordance with the various embodiments of the disclosure are described in greater detail below with respect to FIGS. 1B-1N.

In the illustrated embodiment of FIG. 1A, the environment 101 comprises a household having several rooms, spaces, and/or playback zones, including (clockwise from upper left) a Master Bathroom 101a, a Master Bedroom 101b, a Second Bedroom 101c, a Family Room or Den 101d, an Office 101e, a Living Room 101f, a Dining Room 101g, a Kitchen 101h, and an outdoor Patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The MPS 100 can comprise one or more playback zones, some of which may correspond to the rooms in the environment 101. The MPS 100 can be established with one or more playback zones, after which additional zones may be added and/or removed to form, for example, the configuration shown in FIG. 1A. Each zone may be given a name according to a different room or space such as the Office 101e, Master Bathroom 101a, Master Bedroom 101b, the Second Bedroom 101c, Kitchen 101h, Dining Room 101g, Living Room 101f, and/or the Patio 101i. In some aspects, a single playback zone may include multiple rooms or spaces. In certain aspects, a single room or space may include multiple playback zones.

In the illustrated embodiment of FIG. 1A, the Master Bathroom 101a, the Second Bedroom 101c, the Office 101e, the Living Room 101f, the Dining Room 101g, the Kitchen 101h, and the outdoor Patio 101i each include one playback device 110, and the Master Bedroom 101b and the Den 101d include a plurality of playback devices 110. In the Master Bedroom 101b, the playback devices 110l and 110m may be configured, for example, to play back audio content in synchrony as individual ones of playback devices 110, as a bonded playback zone, as a consolidated playback device, and/or any combination thereof. Similarly, in the Den 101d, the playback devices 110h-j can be configured, for instance, to play back audio content in synchrony as individual ones of playback devices 110, as one or more bonded playback devices, and/or as one or more consolidated playback devices.

Referring to FIG. 1B, the home environment may include additional and/or other computing devices, including local network devices, such as one or more smart illumination devices 108 (FIG. 1B), a smart thermostat 140 (FIG. 1B), and a local computing device 105 (FIG. 1A). Numerous other examples of local network devices (not shown) are also possible, such as doorbells, cameras, smoke alarms, televisions, gaming consoles, garage door openers, etc. In embodiments described below, one or more of the various playback devices 110 may be configured as portable playback devices, while others may be configured as stationary playback devices. For example, the playback device 110o (FIG. 1B) may be a portable playback device that takes the form of a headphone device, while the playback device 110e on the bookcase may be a stationary device. As another example, the playback device 110c on the Patio 101i may be a battery-powered device, which may allow it to be transported to various areas within the environment 101, and outside of the environment 101, when it is not plugged in to a wall outlet or the like.

With reference still to FIG. 1B, the various playback, network microphone, and controller devices and/or other network devices of the MPS 100 may be coupled to one another via point-to-point connections and/or over other connections, which may be wired and/or wireless, via a local network 160 that may include a network router 109. For example, the playback device 110j in the Den 101d (FIG. 1A), which may be designated as the “Left” device, may have a point-to-point connection with the playback device 110k, which is also in the Den 101d and may be designated as the “Right” device. In a related embodiment, the Left playback device 110j may communicate with other network devices, such as the playback device 110h, which may be designated as the “Front” device, via a point-to-point connection and/or other connections via the local network 160.

The local network 160 may be, for example, a network that interconnects one or more devices within a limited area (e.g., a residence, an office building, a car, an individual's workspace, etc.). The local network 160 may include, for example, one or more local area networks (LANs) such as a wireless local area network (WLAN) (e.g., a WIFI network, a Z-Wave network, etc.) and/or one or more personal area networks (PANs) (e.g. a BLUETOOTH network, a wireless USB network, a ZigBee network, an IRDA network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WIFI” can refer to several different communication protocols including, for example, Institute of Electrical and Electronics Engineers (IEEE) 802.11a, 802.11b, 802.11g, 802.12, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, 6 GHz, and/or another suitable frequency.

The MPS 100 is configured to receive media content from the local network 160. The received media content can comprise, for example, a Uniform Resource Identifier (URI) and/or a Uniform Resource Locator (URL). For instance, in some examples, the MPS 100 can stream, download, or otherwise obtain data from a URI or a URL corresponding to the received media content.

As further shown in FIG. 1B, the MPS 100 may be coupled to one or more remote computing devices 106 via a wide area network (“WAN”), such as the network 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio content, in the environment 101 (FIG. 1A).

In some implementations, the various playback devices 110, NMDs 120, and/or control devices 130 may be communicatively coupled to at least one remote computing device associated with a voice assistant service (“VAS”) and/or at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to any number of different VASes and/or MCSes. In some embodiments, the various playback devices 110, NMDs 120, and/or control devices 130 may transmit data associated with a received voice input to a VAS configured to (i) process the received voice input data and (ii) transmit a corresponding command to the MPS 100. In some aspects, for example, the computing devices 106a may comprise one or more modules and/or servers of a VAS. In some implementations, VASes may be operated by one or more of SONOS®, AMAZON®, GOOGLE® APPLE®, MICROSOFT®, NUANCE®, or other voice assistant providers. In some implementations, MCSes may be operated by one or more of SPOTIFY, PANDORA, AMAZON MUSIC, YOUTUBE MUSIC, APPLE MUSIC, GOOGLE PLAY, or other media content services.

In some embodiments, the local network 160 comprises a dedicated communication network that the MPS 100 uses to transmit messages between individual devices and/or to transmit media content to and from MCSes. In certain embodiments, the local network 160 is configured to be accessible only to devices in the MPS 100, thereby reducing interference and competition with other household devices. In other embodiments, however, the local network 160 comprises an existing household communication network (e.g., a household WIFI network). In some embodiments, the MPS 100 is implemented without the local network 160, and the various devices comprising the MPS 100 can communicate with each other, for example, via one or more direct connections, PANs, telecommunication networks (e.g., an LTE network or a 5G network, etc.), and/or other suitable communication links.

In some embodiments, media content sources may be regularly added and/or removed from the MPS 100. In some embodiments, for example, the MPS 100 performs an indexing of media items when one or more media content sources are updated, added to, and/or removed from the MPS 100. The MPS 100 can scan identifiable media items in some or all folders and/or directories accessible to the various playback devices and generate or update a media content database comprising metadata (e.g., title, artist, album, track length) and other associated information (e.g., URIs, URLs) for each identifiable media item found. In some embodiments, for example, the media content database is stored on one or more of the various playback devices, network microphone devices, and/or control devices of MPS 100.

As further shown in FIG. 1B, the remote computing devices 106 further include remote computing device(s) 106c configured to perform certain operations, such as remotely facilitating media playback functions, managing device and system status information, directing communications between the devices of the MPS 100 and one or more VASes and/or MCSes, among other operations. In one example, the remote computing devices 106c provide cloud servers for one or more SONOS Wireless HiFi Systems.

In various implementations, one or more of the playback devices 110 may take the form of or include an on-board (e.g., integrated) network microphone device configured to detect sound, including voice utterances from a user. For example, the playback devices 110c-110h, and 110k include or are otherwise equipped with corresponding NMDs 120c-120h, and 120k, respectively. A playback device that includes or is equipped with an NMD may be referred to herein interchangeably as a playback device or an NMD unless indicated otherwise in the description. In some cases, one or more of the NMDs 120 may be a stand-alone device. For example, the NMD 120l (FIG. 1A) may be a stand-alone device. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 110 and 120 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 110e because it is physically situated on a bookcase. Similarly, the NMD 120l may be assigned the named “Island” because it is physically situated on an island countertop in the Kitchen 101h (FIG. 1A). Some playback devices may be assigned names according to a zone or room, such as the playback devices 110g, 110d, and 110f, which are named “Bedroom,” “Dining Room,” and “Office,” respectively. Further, certain playback devices may have functionally descriptive names. For example, the playback devices 110k and 110h are assigned the names “Right” and “Front,” respectively, because these two devices are configured to provide specific audio channels during media playback in the zone of the Den 101d (FIG. 1A). The playback device 110c in the Patio 101i may be named “Portable” because it is battery-powered and/or readily transportable to different areas of the environment 101. Other naming conventions are possible.

As discussed above, an NMD may detect and process sound from its environment, including audio output played by itself, played by other devices in the environment 101, and/or sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word (also referred to herein as an activation word) associated with a particular VAS.

In the illustrated example of FIG. 1B, the NMDs 120 are configured to interact with the VAS 190 over the local network 160 and/or the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 105, 110, 120, and 130 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. Pat. No. 10,499,146, issued Nov. 13, 2019 and titled “Voice Control of a Media Playback System,” which is herein incorporated by reference in its entirety.

Upon receiving the stream of sound data, the VAS 190 may determine if there is voice input in the streamed data from the NMD, and if so the VAS 190 may also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude” performed by The Beatles. After these determinations, the VAS 190 may transmit a command to a particular MCS 192 to retrieve content (i.e., the song “Hey Jude” by The Beatles), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 110e in the environment 101 (FIG. 1A) is in relatively close proximity to the NMD-equipped Living Room playback device 120b, and both devices 110e and 120b may at least sometimes detect the same sound. In such cases, this may require arbitration as to which device is ultimately responsible for providing detected-sound data to the remote VAS. Examples of arbitrating between NMDs may be found, for example, in previously referenced U.S. Pat. No. 10,499,146.

In certain implementations, an NMD may be assigned to, or otherwise associated with, a designated or default playback device that may not include an NMD. For example, the Island NMD 120l in the Kitchen 101h (FIG. 1A) may be assigned to the Dining Room playback device 110d, which is in relatively close proximity to the Island NMD 120l. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Pat. No. 10,499,146.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback devices 110, network microphone devices 120, and/or control devices 130. For example, the technologies herein may be utilized within an environment having a single playback device 110 and/or a single NMD 120. In some examples of such cases, the local network 160 (FIG. 1B) may be eliminated and the single playback device 110 and/or the single NMD 120 may communicate directly with the remote computing devices 106a-c. In some embodiments, a telecommunication network (e.g., an LTE network, a 5G network, etc.) may communicate with the various playback devices 110, network microphone devices 120, and/or control devices 130 independent of the local network 160.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WIFI, BLUETOOTH, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 150 via the input/output 111 (e.g., a cable, a wire, a PAN, a BLUETOOTH connection, an ad hoc wired or wireless communication network, and/or another suitable communication link). The local audio source 150 can comprise, for example, a mobile device (e.g., a smartphone, a tablet, a laptop computer) or another suitable audio component (e.g., a television, a desktop computer, an amplifier, a phonograph, a DVD player, a Blu-ray player, a game console, a memory storing digital media files). In some aspects, the local audio source 150 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 150. In other embodiments, however, the media playback system omits the local audio source 150 altogether. In some embodiments, the playback device 110a does not include an input/output 111 and receives all audio content via the local network 160.

The playback device 110a further comprises electronics 112, a user interface 113 (e.g., one or more buttons, knobs, dials, touch-sensitive surfaces, displays, touchscreens), and one or more transducers 114 (e.g., a driver), referred to hereinafter as “the transducers 114.” The electronics 112 is configured to receive audio from an audio source (e.g., the local audio source 150) via the input/output 111, one or more of the computing devices 106a-c via the local network 160 (FIG. 1B), amplify the received audio, and output the amplified audio for playback via one or more of the transducers 114. In some embodiments, the playback device 110a optionally includes one or more microphones (e.g., a single microphone, a plurality of microphones, a microphone array) (hereinafter referred to as “the microphones”). In certain embodiments, for example, the playback device 110a having one or more of the optional microphones can operate as an NMD configured to receive voice input from a user and correspondingly perform one or more operations based on the received voice input, which will be discussed in more detail further below with respect to FIGS. 1F and 1G.

In the illustrated embodiment of FIG. 1C, the electronics 112 comprise one or more processors 112a (referred to hereinafter as “the processors 112a”), memory 112b, software components 112c, a network interface 112d, one or more audio processing components 112g, one or more audio amplifiers 112h (referred to hereinafter as “the amplifiers 112h”), and power components 112i (e.g., one or more power supplies, power cables, power receptacles, batteries, induction coils, Power-over Ethernet (POE) interfaces, and/or other suitable sources of electric power).

In some embodiments, the electronics 112 optionally include one or more other components 112j (e.g., one or more sensors, video displays, touchscreens, battery charging bases). In some embodiments, the playback device 110a and electronics 112 may further include one or more voice processing components that are operably coupled to one or more microphones, and other components as described below with reference to FIGS. 1F and 1G.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices and/or zones can be found, for example, in U.S. Pat. No. 8,234,395 entitled “System and method for synchronizing operations among a plurality of independently clocked digital data processing devices,” which is herein incorporated by reference in its entirety.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the MPS 100. In some aspects, for example, the state data is shared during predetermined intervals of time (e.g., every 5 seconds, every 10 seconds, every 60 seconds) among at least a portion of the devices of the MPS 100, so that one or more of the devices have the most recent data associated with the MPS 100.

The network interface 112d is configured to facilitate a transmission of data between the playback device 110a and one or more other devices on a data network. The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the local network 160 (FIG. 1B) in accordance with a suitable wireless communication protocol (e.g., WIFI, BLUETOOTH, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

In some implementations, the power components 112i of the playback device 110a may additionally include an internal power source (e.g., one or more batteries) configured to power the playback device 110a without a physical connection to an external power source. When equipped with the internal power source, the playback device 110a may operate independent of an external power source. In some such implementations, an external power source interface may be configured to facilitate charging the internal power source. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The user interface 113 may facilitate user interactions independent of or in conjunction with user interactions facilitated by one or more of the control devices 130 (FIG. 1A). In various embodiments, the user interface 113 includes one or more physical buttons and/or supports graphical interfaces provided on touch sensitive screen(s) and/or surface(s), among other possibilities, for a user to directly provide input. The user interface 113 may further include one or more light components (e.g., LEDs) and the speakers to provide visual and/or audio feedback to a user.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

In some embodiments, the playback device 110a may include a speaker interface for connecting the playback device to external speakers. In other embodiments, the playback device 110a may include an audio interface for connecting the playback device to an external audio amplifier or audio-visual receiver.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” “SUB,” “ARC,” “MOVE,” “ERA,” and “ROAM.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more of the playback devices 110 may comprise a docking station and/or an interface configured to interact with a docking station for personal mobile media playback devices. In certain embodiments, a playback device may be integrated with another device or component such as a television, a lighting device (e.g., a lamp or other lighting fixture), or some other device for indoor or outdoor use. In some embodiments, a playback device may omit a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with playback device 110i, is configured to render only the mid-range and high frequency components of a particular audio content, while the playback device 110i renders the low frequency component of the particular audio content. In some embodiments, the bonded playback device 110q includes additional playback devices and/or another bonded playback device.

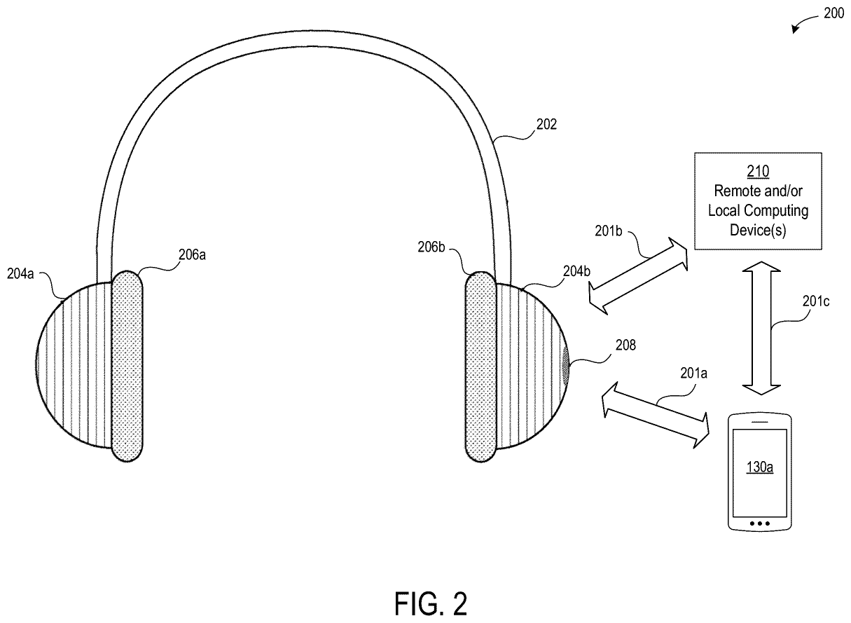

In some embodiments, one or more of the playback devices 110 may take the form of a wired and/or wireless headphone device (e.g., over-ear headphones, on-ear headphones, in-ear earphones, or some other wearable device, etc.). For instance, FIG. 2 shows an example headset assembly 200 (“headset 200”) for such an implementation of one of the playback devices 110. As shown, the headset 200 includes a headband 202 that couples a first earcup 204a to a second earcup 204b. Each of the earcups 204a and 204b may house any portion of the electronic components in the playback device 110, such as one or more speakers. Further, one or both of the earcups 204a and 204b may include a user interface for controlling audio playback, volume level, and other functions. The user interface may include any of a variety of control elements such as a physical button 208, a slider (not shown), a knob (not shown), and/or a touch control surface (not shown). As shown in FIG. 2, the headset 200 may further include ear cushions 206a and 206b that are coupled to earcups 204a and 204b, respectively. The ear cushions 206a and 206b may provide a soft barrier between the head of a user and the earcups 204a and 204b, respectively, to improve user comfort and/or provide acoustic isolation from the ambient (e.g., passive noise reduction (PNR)).

As described in greater detail below, the electronic components of a playback device may include one or more network interface components (not shown in FIG. 2) to facilitate wireless communication over one more communication links. For instance, a playback device may communicate over a first communication link 201a (e.g., a BLUETOOTH link) with one of the control devices 130, such as the control device 130a, and/or over a second communication link 201b (e.g., a WIFI or cellular link) with one or more other computing devices 410 (e.g., a network router and/or a remote server). As another possibility, a playback device may communicate over multiple communication links, such as the first communication link 201a with the control device 130a and a third communication link 201c (e.g., a WIFI or cellular link) between the control device 130a and the one or more other computing devices 410. Thus, the control device 130a may function as an intermediary between the playback device and the one or more other computing devices 410, in some embodiments.

In some instances, the headphone device may take the form of a hearable device. Hearable devices may include those headphone devices (including ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.)

It should be appreciated that one or more of the playback devices 110 may take the form of other wearable devices separate and apart from a headphone device. Wearable devices may include those devices configured to be worn about a portion of a user (e.g., a head, a neck, a torso, an arm, a wrist, a finger, a leg, an ankle, etc.). For example, the playback devices 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

c. Suitable Network Microphone Devices (NMDs)

FIG. 1F is a block diagram of the NMD 120a (FIGS. 1A and 1B). The NMD 120a includes one or more voice processing components 124 and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an IoT device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise any or all of the components of the playback device 110a and further include the microphones 115 and voice processing components 124 (FIG. 1F). The microphones 115 are configured to detect sound (i.e., acoustic waves) in the environment of the playback device 110r, which may then be provided to voice processing components 124. More specifically, each microphone 115 is configured to detect sound and convert the sound into a digital or analog signal representative of the detected sound, which can then cause the voice processing component to perform various functions based on the detected sound, as described in greater detail below. In some implementations, the microphones 115 may be arranged as an array of microphones (e.g., an array of six microphones). In some implementations the playback device 110r may include fewer than six microphones or more than six microphones. The playback device 110r optionally includes an integrated control device 130c. The control device 130c can comprise, for example, a user interface configured to receive user input (e.g., touch input, voice input) without a separate control device. In other embodiments, however, the playback device 110r receives commands from another control device (e.g., the control device 130a of FIG. 1B).

In operation, the voice-processing components 124 are generally configured to detect and process sound received via the microphones 115, identify potential voice input in the detected sound, and extract detected-sound data to enable a VAS, such as the VAS 190 (FIG. 1B), to process voice input identified in the detected-sound data. The voice processing components 124 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 124 may include or otherwise take the form of one or more DSPs or one or more modules of a DSP. In this respect, certain voice processing components 124 may be configured with particular parameters (e.g., gain and/or spectral parameters) that may be modified or otherwise tuned to achieve particular functions. In some implementations, one or more of the voice processing components 124 may be a subcomponent of the processor 112a.

In some implementations, the voice-processing components 124 may detect and store a user's voice profile, which may be associated with a user account of the MPS 100. For example, voice profiles may be stored as and/or compared to variables stored in a set of command information or data table. The voice profile may include aspects of the tone of frequency of a user's voice and/or other unique aspects of the user's voice, such as those described in previously-referenced U.S. Pat. No. 10,499,146.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The NMD 120a may use the microphone data (or transmit the microphone data to another device) for calibrating the audio characteristics of one or more playback devices 110 in the MPS 100. As another example, one or more of the playback devices 110, NMDs 120, and/or control devices 130 of the MPS 100 may transmit audio tones (e.g., ultrasonic tones, infrasonic tones) that may be detectable by the microphones 115 of other devices, and which may convey information such as a proximity and/or identity of the transmitting device, a media playback system command, etc. As yet another example, the voice processing components 124 may receive and analyze the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partially schematic diagram of one example of the control device 130a (FIGS. 1A and 1B). As used herein, the term “control device” can be used interchangeably with “controller,” “controller device,” or “control system.” Among other features, the control device 130a is configured to receive user input related to the MPS 100 and, in response, cause one or more devices in the MPS 100 to perform an action(s) and/or an operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the MPS 100. In other embodiments, as described above with respect to FIG. 1G, the control device 130a is integrated into another device in the MPS 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processor(s) 132a”), a memory 132b, software components 132c, and a network interface 132d. The processor(s) 132a can be configured to perform functions relevant to facilitating user access, control, and configuration of the MPS 100. The memory 132b can comprise data storage that can be loaded with one or more of the software components executable by the processors 132a to perform those functions. The software components 132c can comprise applications and/or other executable software configured to facilitate control of the MPS 100. The memory 132b can be configured to store, for example, the software components 132c, media playback system controller application software, and/or other data associated with the MPS 100 and the user.

The network interface 132d is configured to facilitate network communications between the control device 130a and one or more other devices in the MPS 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.12, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among other changes. Additional description of zones and groups can be found below with respect to FIGS. 1J through 1N.

The user interface 133 is configured to receive user input and can facilitate control of the MPS 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system. FIG. 1I shows two additional example user interface displays 133f and 133g of user interface 133. Additional examples are also possible.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

e. Suitable Playback Device Configurations

FIGS. 1J, 1K, 1L, 1M, and IN show example configurations of playback devices in zones and zone groups. Referring first to FIG. 1N, in one example, a single playback device may belong to a zone. For example, the playback device 110g in the Second Bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities), as will be described in more detail further below. In other implementations, multiple playback devices may be merged to form a single zone. As one example, the playback device 110a can be bonded to the playback device 110n and the NMD 120c to form Zone A. As another example, the playback device 110h (e.g., a front playback device) may be merged with the playback device 110i (e.g., a subwoofer), and the playback devices 110j and 110k (e.g., left and right surround speakers, respectively) to form a single Zone D. In yet other implementations, one or more playback zones can be merged to form a zone group (which may also be referred to herein as a merged group). As one example, the playback zones Zone A and Zone B can be merged to form Zone Group 108a. As another example, the playback zones Zone G and Zone H can be merged to form Zone Group 108b. The merged playback zones Zone G and Zone H may not be specifically assigned different playback responsibilities. That is, the merged playback zones Zone G and Zone H may, aside from playing audio content in synchrony, each play audio content as they would if they were not merged and operating as independent zones.

Each zone in the MPS 100 may be represented for control as a single user interface (UI) entity. For example, Zone A may be represented as a single entity named Master Bathroom. Zone B may be represented as a single entity named Master Bedroom. Zone C may be represented as a single entity named Second Bedroom.

In some implementations, as mentioned above playback devices that are bonded may have different playback responsibilities, such as responsibilities for certain audio channels. For example, as shown in FIG. 1J, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1K, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1L shows the Front and SUB devices 110h and 110i further bonded with Left and Right playback devices 110j and 110k, respectively. In some implementations, the Right and Left devices 110j and 110k can be configured to form surround or “satellite” channels of a home theater system. The bonded playback devices 110h, 110i, 110j, and 110k may form a single Zone D (FIG. 1N).

In other implementations, playback devices that are merged may not have assigned playback responsibilities and may each render the full range of audio content of which the respective playback device is capable. Nevertheless, merged devices may be represented as a single UI entity (i.e., a zone, as discussed above). For instance, the playback devices 110a and 110n in the Master Bathroom have the single UI entity of Zone A. In one embodiment, the playback devices 110a and 110n may each output the full range of audio content of which each respective playback devices 110a and 110n is capable, in synchrony.

In some embodiments, an NMD may be bonded or merged with one or more other devices so as to form a zone. As one example, the NMD 120c may be merged with the playback devices 110a and 110n to form Zone A. As another example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. Pat. No. 10,499,146.

As mentioned above, in some implementations, zones of individual, bonded, and/or merged devices may be grouped to form a zone group. For example, referring to FIG. 1N, Zone A may be grouped with Zone B to form a zone group 108a that includes the two zones, and Zone G may be grouped with Zone H to form the zone group 108b. However, other zone groupings are also possible. For example, Zone A may be grouped with one or more other Zones C-I. The Zones A-I may be grouped and ungrouped in numerous ways. For example, three, four, five, or more (e.g., all) of the Zones A-I may be grouped at any given time. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zone groups in an environment may be named by according to a name of a zone within the group or a combination of the names of the zones within a zone group. For example, Zone Group 108b can be assigned a name such as “Dining+Kitchen”, as shown in FIG. 1N. In other implementations, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the Second Bedroom 101c may indicate (i) that the playback device 110g is the only playback device of the Zone C and (ii) that Zone C is not in a zone group. Identifiers associated with the Den 101d may indicate that the Den 101d is not grouped with other zones but includes bonded playback devices 110h-110k. Identifiers associated with the Dining Room 101g may indicate that the Dining Room 101g is part of the Dining+Kitchen Zone Group 108b and that devices 110d and 110b (Kitchen 101h) are grouped (FIGS. 1M, 1N). Identifiers associated with the Kitchen 101h may indicate the same or similar information by virtue of the Kitchen 101h being part of the Dining+Kitchen Zone Group 108b. Other example zone variables and identifiers are described below.

In yet another example, the MPS 100 may include variables or identifiers representing other associations of zones and zone groups, such as identifiers associated with Areas, as shown in FIG. 1N. An area may involve a cluster of zone groups and/or zones not within a zone group. For instance, FIG. 1N shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, issued Jul. 14, 2020, and titled “Room Association Based on Name,” and U.S. Pat. No. 8,483,853, filed Sep. 11, 2007, issued Jul. 9, 2013, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

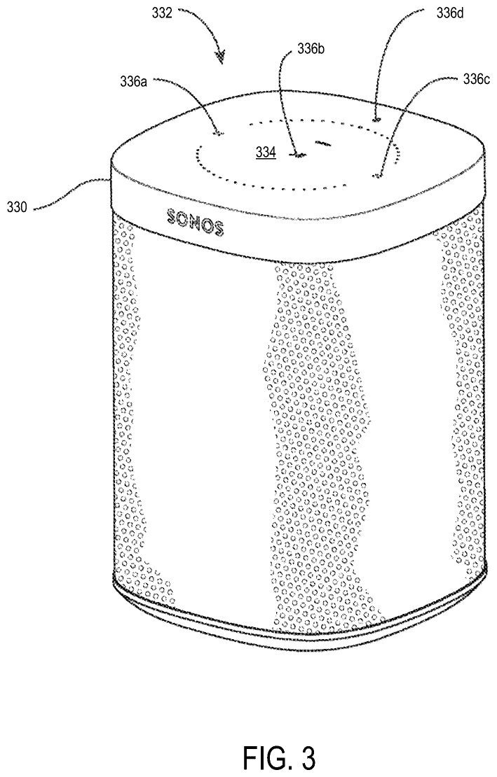

FIG. 3 shows an example housing 330 of the playback device 110 that includes a user interface in the form of a control area 332 at a top portion 334 of the housing 330. The control area 332 includes buttons 336a, 336b, and 336c for controlling audio playback, volume level, and other functions. The control area 332 also includes a button 336d for toggling one or more microphones (not visible in FIG. 3) of the playback device 110 to either an on state or an off state. The control area 332 is at least partially surrounded by apertures formed in the top portion 334 of the housing 330 through which the microphones receive the sound in the environment of the playback device 110. The microphones may be arranged in various positions along and/or within the top portion 334 or other areas of the housing 330 so as to detect sound from one or more directions relative to the playback device 110.

f. Audio Content

Audio content may be any type of audio content now known or later developed. For example, in some embodiments, the audio content includes any one or more of: (i) streaming music or other audio obtained from a streaming media service, such as Spotify, Pandora, or other streaming media services; (ii) streaming music or other audio from a local music library, such as a music library stored on a user's laptop computer, desktop computer, smartphone, tablet, home server, or other computing device now known or later developed; (iii) audio content associated with video content, such as audio associated with a television program or movie received from any of a television, set-top box, Digital Video Recorder, Digital Video Disc player, streaming video service, or any other source of audio-visual media content now known or later developed; (iv) text-to-speech or other audible content from a voice assistant service (VAS), such as Amazon Alexa, Google Assistant, or other VAS services now known or later developed; (v) audio content from a doorbell or intercom system such as Nest, Ring, or other doorbells or intercom systems now known or later developed; and/or (vi) audio content from a telephone, video phone, video/teleconferencing system or other application configured to allow users to communicate with each other via audio and/or video.

In operation, a “sourcing” playback device obtains any of the aforementioned types of audio content from an audio source via an interface on the playback device, e.g., one of the sourcing playback device's network interfaces, a “line-in” analog interface, a digital audio interface, or any other interface suitable for receiving audio content in digital or analog format now known or later developed.

An audio source is any system, device, or application that generates, provides, or otherwise makes available any of the aforementioned audio content to a playback device. For example, in some embodiments, an audio source includes any one or more of a streaming media (audio, video) service, digital media server or other computing system, VAS service, television, cable set-top-box, streaming media player (e.g., AppleTV, Roku, gaming console), CD/DVD player, doorbell, intercom, telephone, tablet, or any other source of digital audio content.

A playback device that receives or otherwise obtains audio content from an audio source for playback and/or distribution to other playback devices may be referred to herein as the “sourcing” playback device, “master” playback device, a “group coordinator” playback device, or simply a “group coordinator.” One function of the “sourcing” playback device is to process received audio content for playback and/or distribution to other playback devices. In some embodiments, the sourcing playback device transmits the processed audio content to all the playback devices that are configured to play the audio content. In other embodiments, the sourcing playback device transmits the processed audio content to a multicast network address, and all the other playback devices configured to play the audio content receive the audio content via that multicast address. In yet other embodiments, the sourcing playback device alternatively transmits the processed audio content to a respective unicast network address of each other playback device configured to play the audio content, and each of the other playback devices configured to play the audio content receive the audio content via its respective unicast address.

Further, in an instance involving a playback group comprising two or more media playback devices of a local media playback system that are grouped for synchronous playback of media content (which may be referred to herein as a synchrony group), monitoring and/or management of the media playback devices, the media playback system, and/or the media content being played back may be particularly desirable. The playback group may be part of a local media playback system wherein each of the group coordinator and group members is configured to coordinate and/or communicate over a local data network (e.g., wireless local area network) that is provided by one or more local network devices (e.g., WIFI router). The local network may be provided by an access point, such as a local WIFI router. The local network may also be used to communicate with one or more remote computing devices associated with one or more media content sources for retrieval of media content.

In such an instance, a group coordinator playback device may generally be responsible for various tasks, including but not limited to identifying (and/or retrieving) media content for playback by the group members of the playback group, monitoring playback device characteristics of one or more group members, monitoring network characteristics associated with the network device and one or more group members, monitoring group characteristics, and dynamically modifying media content for playback based on a change in one or more characteristics. To facilitate performance of these and other tasks, a playback device (e.g., a group coordinator playback device) may generally have access to numerous types of media content sources, such as audio and video streaming services, content libraries, and local device storage, among other examples. Additional information about setting up media playback devices within a media playback system can be found in U.S. Patent Pub. No. 2022/0104015, filed Sep. 24, 2021, and titled “Intelligent Setup for Playback Devices,” the contents of which are incorporated herein by reference in their entirety.

Additionally, or alternatively, the group coordinator playback device may distribute audio content to the playback devices that are configured to play back the audio content in accordance with one or more distribution schemes based on the computational capabilities of the playback devices. More information about such distribution schemes and playback device classes may be found in U.S. Patent Pub. No. 2022/0131511, filed Oct. 22, 2021, and titled “Techniques for Enabling Interoperability between Media Playback Systems,” U.S. Patent Pub. No. 2022/0358187, filed May 10, 2022, and titled “Audio Encryption in a Media Playback System,” and PCT Pub. No. WO 2022/240854, filed May 10, 2022, and titled “Audio Encryption in a Media Playback System,” the contents of each of which are incorporated by reference herein in their entirety.

### III. Example Intelligent Control Interface

In line with the discussion above, a multi-purpose playback device (which may also be referred to herein as simply a playback device) may include hardware that supports functionality in addition to playback of media content, such as lighting hardware (e.g., one or more light bulbs, LEDs, etc.), among other possibilities. Beneficially, the playback device may include a control interface that takes up relatively minimal space on a surface of the playback device and enables control of the different functions of the playback device (e.g., both media playback functionality and lighting functionality). For instance, the control interface may be situated within, or comprise a part of, an external housing of the playback device. The playback device comprising the disclosed control interface may (i) detect user input initiated at a given location of the control interface, (ii) based on the given location, determine a given setting of the playback device that is to be adjusted, (iii) based on the user input, determine a command to adjust the given setting, and (iv) adjust the given setting based on the command.

In general, the disclosed intelligent control interface may comprise a touch sensor, such as a touch-sensitive printed circuit board, that is integrated with a playback device. Further, the control interface may comprise various regions that each corresponds to a given setting of the playback device. Based on a set of inputs initiated at a location within a given region of the control interface, the playback device may determine (i) a setting that is to be adjusted and (ii) a command to adjust the setting.

The playback device may determine a setting that is to be adjusted in various ways. In one embodiment, the playback device may determine the setting that is to be adjusted based on a location at which the set of inputs is initiated. In this respect, the control interface may be logically divided into respective regions corresponding to each setting that is available for adjustment via the control interface. For instance, as one possibility, the entire surface of the control interface may be logically divided into respective regions corresponding to each setting. For example, the surface of a control interface that can be used to control two different settings of a playback device may be logically divided into two regions, where a first region (e.g., a first half of the control interface, a given area of the first half of the control interface, etc.) of the control interface corresponds to a first setting of the playback device and a second region (e.g., a second half of the control interface, a given area of the second half of the control interface, etc.) of the control interface corresponds to a second setting of the playback device. In such instances, a set of inputs initiated at a location in the first region (e.g., the first half) of the control interface may indicate that the first setting is to be adjusted, and a set of inputs initiated at a location in the second region (e.g., the second half) of the control interface may indicate that the second setting is to be adjusted.

Each region of a control interface that corresponds to a setting available for adjustment may be indicated by a visual indicator. For example, in one embodiment, a region corresponding to a given setting may be indicated by a respective visual icon for the given setting. In general, a respective visual icon corresponding to a setting that may be controlled using the disclosed control interface may comprise an icon that is commonly associated with and/or widely recognized as corresponding to the setting. For example, a speaker icon displayed at the control interface may indicate a region corresponding to a sound setting of the playback device. As another example, a lightbulb icon displayed at the control interface may indicate a region corresponding to a light setting of the playback device. As yet another example, a musical note icon displayed at the control interface may indicate a region corresponding to a media content setting of the playback device. As a further example, a play/pause icon displayed at the control interface may indicate a region corresponding to a playback setting of the playback device. Other examples are also possible.

In some embodiments, the display of the visual indicators may depend on whether or not user input is detected at the control interface. For instance, when the control interface detects no user input (e.g., no setting is selected for adjustment), the respective visual icons of all available adjustable settings may be displayed to indicate that user input may be initiated at a location in any region of the control interface to control a corresponding one of the settings. Once the control interface detects that user input has been initiated at a location in a given region and determines that a given setting has been selected for adjustment, only the respective visual icon for the given setting may continue to be displayed (e.g., for the duration of a continuous set of user inputs), and the respective visual icons for any other settings may stop being displayed. Further, in some implementations, the respective visual icon of the given setting may be visually highlighted to indicate that the given setting is currently selected for adjustment. For instance, the respective visual icon of the given setting may be illuminated to indicate that the given setting is currently selected for adjustment. In some implementations, the playback device may output an audio alert indicating the given setting that has been selected for adjustment. Alternatively, in some embodiments, the visual indicators corresponding to each adjustable setting may be displayed permanently on the control interface. Other examples are also possible.

The playback device may determine a setting that is to be adjusted in other ways as well.

The playback device may determine a command to adjust a selected setting in various ways. In general, the playback device may determine the command to adjust the selected setting based on the set of inputs received at the control interface. For example, in one embodiment, the set of inputs may collectively comprise a touch, a drag, and a release on the control interface and may be referred to herein as a touch-drag-release input. In this respect, it should be understood that each set of inputs (e.g., each touch-drag-release input) may be provided continuously from an initial touch to a release. Based on the set of inputs (i.e., a direction of the drag input in the set of inputs), the playback device may adjust a value of the selected setting (e.g., a setting that was selected based on initiating the set of inputs at a location in a given region of the control interface). For instance, a value of a selected setting may be increased by a drag input in a first direction and decreased by a drag input in a second direction. In this respect, a user may drag back and forth (as part of a single, continuous set of inputs) between two directions until a desired setting value is reached.

In line with the discussion above, it should be understood that once the control interface detects that a set of user inputs has been initiated at a location in a given region, the control interface may be configured to treat inputs received at other regions of the control interface as part of the set of user inputs rather than a new set of user inputs indicating a different setting for adjustment. For instance, it is possible that after initiating a set of inputs at a first location in a first region of the control interface to adjust a first setting of the playback device, a user may continuously drag back and forth between two directions across other regions of the control interface, corresponding to other settings, to determine a desired value for the first setting. In this respect, once the control interface detects that the first setting has been selected for adjustment, the control interface may determine that the continuous set of inputs is to be treated as a command for adjusting the first setting until the set of inputs ends (i.e., until the drag input ends and a release is detected).

In some implementations, a certain region (or regions) of the control interface may control more than a single setting. For instance, a certain region of the control interface may enable toggling between states of the playback device (e.g., on or off), or enable a certain type of device command (e.g., device grouping commands), and/or enable a set of playback commands (e.g., transport control commands such as play, pause, skip forward, skip backward, etc.), rather than controlling a setting which is adjustable across a range of values. In such implementations, the value of such a setting and/or behavior of the playback device may similarly be adjusted via a set of inputs that is initiated at a location in the certain region and perhaps also provided in a certain manner. In this regard, the set of inputs may include a touch and release on the control interface, which may collectively be referred to as a “tap.” For instance, a first tap provided at the region corresponding to the setting may cause the value of the setting to be set to a first value, a second tap may cause the value of the setting to be adjusted from the first value to the second value, a third tap may cause the value of the setting to be adjusted from the second value back to the first value, and so forth. Other examples are also possible. For instance, a tap input may comprise various durations of time, such that a “short” tap provided at the certain region may cause the playback device to engage in a first behavior, and a “long” tap provided at the certain region may cause the playback device to engage in a second behavior, among other possibilities. Further, a tap input may comprise a series of taps, such that a “double” tap provided at the certain region may cause the playback device to engage in a third behavior, and a “triple” tap provided at the certain region may cause the playback device to engage in a fourth behavior. Many other examples are possible.

The various settings that may be controlled via the disclosed control interface may take various forms, some examples of which are discussed below.

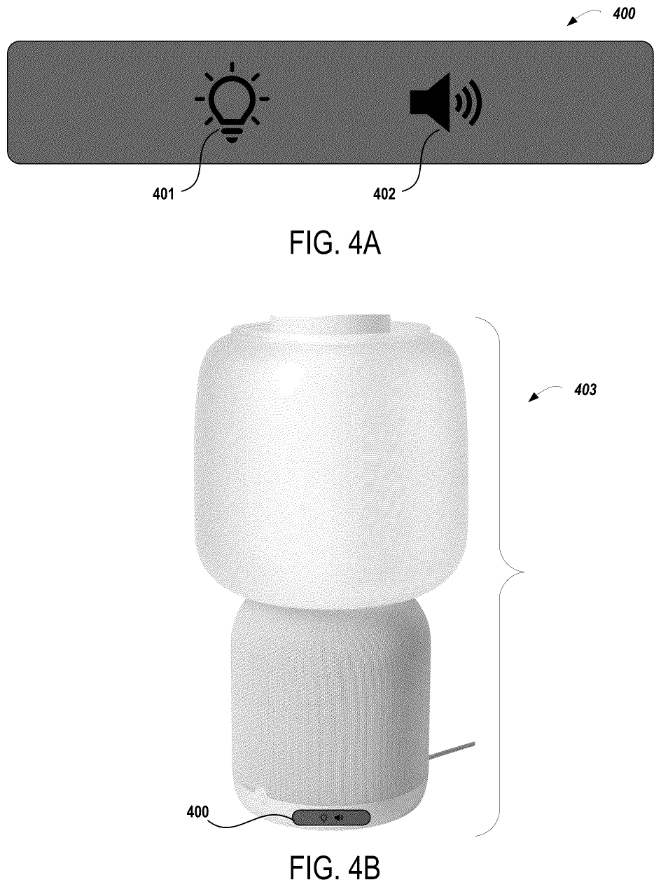

FIG. 4A depicts an example of an intelligent control interface of a playback device according to one embodiment of the disclosed technology. In the example of FIG. 4A, the control interface takes the form of a capacitive control strip 400 that may be used to control two different settings of the playback device. In line with the discussion above, the control strip 400 may comprise two regions respectively corresponding to the two settings, which may be indicated by respective visual icons 401 and 402. The icon 401, which comprises a lightbulb icon, may indicate a first region that corresponds to a light setting of the playback device. For instance, a set of inputs initiated at a location in the first region may indicate selection of the light setting (e.g., a brightness level) of the playback device for adjustment. The icon 402, which comprises a speaker icon, may indicate a second region that corresponds to a sound setting of the playback device. For instance, a set of inputs initiated at a location in the second region may indicate selection of the sound setting (e.g., a volume level) of the playback device for adjustment.

In line with the discussion above, the capacitive control strip 400 may be integrated with a multi-purpose playback device that is configured for multiple functionalities. For instance, as shown in FIG. 4B, the capacitive control strip 400 may be integrated with a multi-purpose playback device 403 that comprises an illumination device and is configured for both sound production and light production. Accordingly, the capacitive control strip 400 may be used to adjust a sound setting (e.g., a volume level) and a light setting (e.g., a brightness level) of the playback device 403. For example, a set of inputs initiated at a location in the first region of the control strip 400 (e.g., the region comprising the icon 401) may indicate a command to adjust the brightness level of the playback device. As another example, a set of inputs initiated at a location in the second region of the control strip 400 (e.g., the region comprising the icon 402) may indicate a command to adjust the volume level of the playback device.

In some implementations, the capacitive control strip 400 may be integrated with a playback device that is communicatively coupled with a separate illumination device capable of light production and may be used to control both a sound setting of the playback device and a light setting of the illumination device based on a set of inputs received at the capacitive control strip of the playback device in line with the discussion above. In some such implementations, a user may be prompted (e.g., at the time of configuring the playback device) to indicate one or more separate devices that may be controlled via the capacitive control strip of the playback device. Further yet, in still other implementations, the capacitive control strip may be a stand-alone capacitive control interface that may be configured to control functionalities of one or more separate devices. Such a separate device may be any network-enabled device within communication range of the capacitive control strip 400. Other examples are also possible.

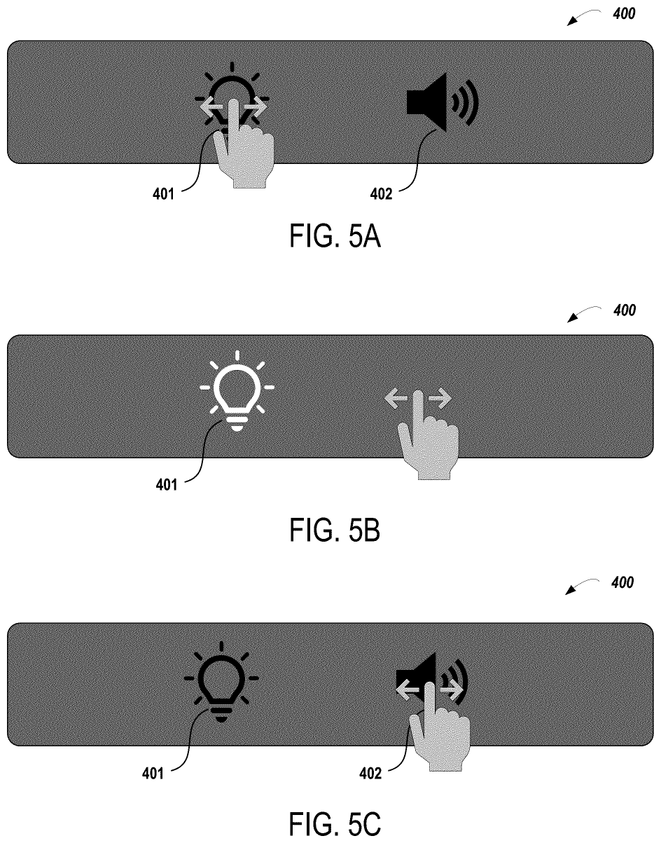

FIGS. 5A, 5B, and 5C illustrate how the capacitive control strip 400 of the playback device 403 enables a user to control a given setting of the playback device 403 via a set of user inputs provided at a location in a given region (as indicated by a respective visual icon) of the capacitive control strip 400. As shown in FIG. 5A, a user may adjust a brightness level of the playback device 403 by initiating a first set of inputs (e.g., touch, drag, and release) at a first location in the first region of the capacitive control strip 400. For instance, the user may initiate the first set of inputs at or near the icon 401 and drag in a first direction (e.g., a right direction) to increase a value of the brightness level of the playback device 403 and/or drag in a second direction (e.g., a left direction) to decrease the value of the brightness level. In line with the discussion above, in the example shown in FIG. 5B, once the user has initiated the set of inputs at the first location and thereby selected the light setting for adjustment, the playback device 403 may indicate the user's selection by causing the icon 401 to be illuminated and discontinuing display of the visual icon 402 corresponding to the second region for controlling the volume level of the playback device 403. The playback device 403 may continue to detect the first set of inputs for adjusting the brightness level until the drag input ends and a release is detected, indicating that the first set of inputs is complete.

Notably, as shown in FIG. 5B, the user may drag their finger, as part of the first set of inputs, across the location on the capacitive control strip 400 that was formerly occupied by the icon 402 corresponding to audio controls. However, because the first set of inputs was initiated at the first location, the command determined by the playback device 403 will be a command for adjustment of the light setting, and the audio setting will not be affected.

In this respect, the playback device 403 may adjust the selected setting in various ways. For instance, in one implementation, the playback device 403 may adjust the selected setting in real-time such that the adjustment is perceived by the user as substantially instantaneously responsive to the drag input provided at the capacitive control strip 400. For instance, when the playback device 403 detects that the user has initiated a first set of inputs at a first location in the first region indicated by the icon 401, the playback device 403 may determine that the light setting is to be adjusted. Based on the first set of inputs (e.g., the user dragging their finger in a first and/or second direction across the control strip), the playback device 403 may determine a command to adjust a value of the brightness level (e.g., increase and/or decrease the value). In this respect, the playback device 403 may dynamically update the value of the brightness level based on the drag input included in the first set of inputs (e.g., for each discrete drag of the drag input in the first set of inputs corresponding to an adjusted brightness level). For instance, the playback device 403 may cause the value of the brightness level (e.g., in a local memory) corresponding to the most recent value adjustment of the brightness level to be used as a current value for the brightness level. In this way, the user may provide a drag input in a continuous manner across the control interface 400 to continuously adjust the brightness level of the playback device 403. The user may end the first set of inputs (e.g., by stopping the drag input and releasing their finger) when the desired brightness level is reached. More information about dynamically updating a value of a setting based on user input received via an on-player hardware interface can be found in U.S. application Ser. No. 18/475,020, filed Sep. 26, 2023, and entitled “Dynamic Volume Control,” the contents of which are herein incorporated by reference in their entirety.

In some other implementations, the playback device 403 may update the value of the selected settings after determining that the first set of inputs is complete.

After determining that the set of user inputs is complete and adjusting the selected setting based on the set of user inputs as described above, the playback device 403 may cause the capacitive control strip to cease illuminating the icon 401 and resume display of the icon 402, thereby indicating that both the sound and the light settings are available to be selected for adjustment, whereupon the user may provide a second set of inputs to adjust a setting of the playback device. In some implementations, as mentioned above, the visual icons 401 and 402 may be permanently displayed. In such implementations, the capacitive control 400 may illuminate a first icon based on detecting a first set of inputs initiated at a first location of a first region corresponding to a first setting of the playback device and continue to display a second (unilluminated) icon indicating a second region corresponding to a second setting of the playback device while the first set of inputs is being provided. In line with the discussion above, because the first set of inputs was initiated at the first location in the first region, the adjustment command determined by the playback device 403 will be a command to adjust the first setting, and not the second setting, of the playback device, even if the drag input included in the first set of inputs traverses the second location of the second region corresponding to the second setting of the playback device. Then, after determining that the first set of user inputs is complete, the playback device 403 may cause the capacitive control strip to cease illuminating the icon 401 and continue displaying the (unilluminated) icons 401 and 402, thereby indicating that both the sound and the light settings are available to be selected for adjustment, whereupon the user may provide a second set of inputs to adjust a setting of the playback device (e.g., a set of inputs to further adjust the light setting or a set of inputs to adjust the sound setting).

For instance, as shown in FIG. 5C, the user may provide a second set of inputs indicating a command to adjust the sound setting (e.g., volume level) of the playback device 403. For example, the user may initiate the second set of inputs (e.g., a second touch-drag-release input) at a second location in the second region of the capacitive control strip 400 indicated by the icon 402. In line with the discussion above, the user may drag in a left and/or a right direction to decrease and/or increase the volume level of the playback device 403.

The disclosed control interface may take other forms and may be used to control other settings of a playback device as well.

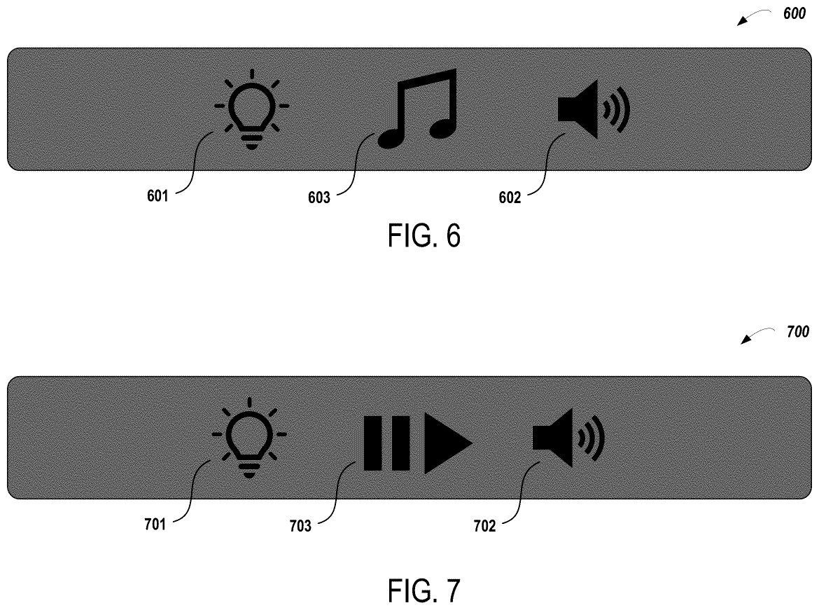

FIG. 6 depicts an example of an intelligent control interface of a multi-purpose playback device according to a second embodiment of the disclosed technology. In the example of FIG. 6, the control interface takes the form of a capacitive control strip 600 that may be used to control three different settings of the playback device. In line with the discussion above, the control strip 600 may comprise three regions respectively corresponding to the three settings, which may be indicated by respective visual icons 601, 602, and 603. The icon 601, which comprises a lightbulb icon, may indicate a first region that corresponds to a light setting (e.g., a brightness level) of the playback device. For instance, a set of inputs initiated at a location in the first region may indicate selection of the brightness level of the playback device for adjustment. The icon 602, which comprises a speaker icon, may indicate a second region that corresponds to a sound setting (e.g., a volume level) of the playback device. For instance, a set of inputs initiated at a location in the second region may indicate selection of the volume level of the playback device for adjustment. The icon 603, which comprises a musical note icon, may indicate a third region that corresponds to a music setting (e.g., content selection) of the playback device. For instance, a set of inputs initiated at a location in the third region may indicate selection of a type of audio content to be played back the playback device. In this respect, the music setting may take various forms.

For example, as one possibility, the music setting may comprise a set of two or more pre-determined audio content, where different locations along the control strip 600 correspond to respective pre-determined audio content. A set of inputs (e.g., a touch-drag-release input) that is initiated at the third region of the control strip 600 indicated by the icon 603 may enable a user to navigate the set of pre-determined audio content and select given audio content by releasing the drag input when desired audio content is reached. In response to the set of inputs, the playback device may determine a command to play back the given audio content and may execute the command by playing back the given audio content. In this respect, in line with the discussion above, the playback device may dynamically play back various pre-determined audio content as the user navigates the set of pre-determined audio content by dragging their finger across the different locations along the control strip 600 that correspond to respective pre-determined audio content.

As another possibility, the music setting may comprise a set of two or more pre-determined audio content (e.g., quick-starts including internet radio stations, podcasts, etc.), where different locations along the control strip 600 correspond to respective pre-determined audio content. As one example, the different locations may correspond to different styles (e.g., musical genres) of audio content. A set of inputs that is initiated at a location in the third region of the control strip 600 indicated by the icon 603 may enable a user to navigate the set of pre-determined styles of audio content and select a given style of audio content for playback by releasing the drag input when the desired style is reached. In response, the playback device may play back the given style of audio content. In this respect, in line with the discussion above, the playback device may dynamically play back the various styles of audio content as the user navigates the set of pre-determined audio content by dragging their finger across the different locations along the control strip 600 that correspond to respective audio content styles.

As yet another possibility, the music setting may comprise a set of two or more pre-determined audio content (or pre-determined styles of audio content) that comprises varying degrees of musical “intensity,” where different locations along the control strip 600 correspond to different musical intensities. A set of inputs that is initiated at the third region of the control strip 600 indicated by the icon 603 may enable a user to navigate the set of pre-determined audio content and select given audio content for playback by releasing the drag input when content or a style with a desired musical intensity is reached. For instance, dragging in a first (e.g., right) direction may produce audio content that is increasingly “wild” or “heavy,” whereas dragging input in a second (e.g., left) direction may produce audio content that is increasingly “calm” or “light.” In this respect, in line with the discussion above, the playback device may dynamically play back the various intensities of audio content as the user navigates the set of pre-determined audio content by dragging their finger across the different locations along the control strip 600 that correspond to the different intensities.

The music setting may take other forms as well.

In line with the discussion above, a user may interact with the capacitive control strip 600 of the playback device to adjust one or more of the light setting, the sound setting, or the music setting of the playback device. For instance, the user may initiate a set of inputs at a location in a given region indicated by a given one of the icons 601-603 to select a given setting for adjustment, continuously provide a drag input in a left and/or right direction to decrease and/or increase a value of the given setting, and then release their finger, ending the set of inputs when a desired value of the given setting is reached. In line with the discussion above, the playback device may dynamically update the value of the given setting based on the discrete drag input(s).

FIG. 7 depicts an example of an intelligent control interface of a multi-purpose playback device according to a third embodiment of the disclosed technology. In the example of FIG. 7, the control interface takes the form of a capacitive control strip 700 that may be used to control three different settings of the playback device. In line with the discussion above, the control strip 700 may comprise three regions respectively corresponding to the three settings, which may be indicated by respective visual icons 701, 702, and 703. The icon 701, which comprises a lightbulb icon, may indicate a first region that corresponds to a light setting (e.g., a brightness level) of the playback device. For instance, a set of inputs initiated at a location in the first region may indicate selection of the brightness level of the playback device for adjustment. The icon 702, which comprises a speaker icon, may indicate a second region that corresponds to a sound setting (e.g., a volume level) of the playback device. For instance, a set of inputs initiated at a location in the second region may indicate selection of the volume level of the playback device for adjustment. The icon 703, which comprises a play/pause icon, may indicate a third region that corresponds to a playback setting (e.g., a play/pause setting) of the playback device.

In line with the discussion above, a user may interact with the capacitive control strip 700 of the playback device to adjust one or more of the light setting or the sound setting of the playback device. For instance, the user may initiate a set of inputs at a location in a given region indicated by a given one of the icons 701 or 702 to select a given setting for adjustment, continuously provide a drag input in a left or right direction to decrease or increase a value of the given setting, and then release their finger, ending the set of inputs when a desired value of the given setting is reached. In line with the discussion above, the playback device may dynamically update the value of the given setting based on the drag input(s).

Further, the user may interact with the capacitive control strip 700 of the playback device to adjust a play/pause setting of the playback device. As mentioned above, certain settings, like the play/pause setting, may control whether the setting is set to a first value (e.g., play content) or set to a second value (e.g., pause content), among other possibilities. The value of such a setting may be controlled via a set of inputs (e.g., a touch and release) provided at a region corresponding to the setting.

For instance, a tap input provided at the third region indicated by the icon 703 may cause the play/pause setting to be set to the first value or adjusted from the first value to the second value. In this respect, each successive tap input provided at the third region indicated by the icon 703 may cause the value of the play/pause setting to toggle between the first value to the second value (e.g., toggle between playing back and pausing audio content). For instance, selecting the icon 703 while the playback device is not playing back audio content may cause the playback device to begin playing back audio content. In this respect, the playback device may identify audio content for playback in various ways. For instance, as one possibility, the playback device may resume playback of previously-paused audio content. As another possibility, the playback device may begin play back of audio content in a playback queue associated with the playback device. Other examples are also possible. Similarly, selecting the icon 703 while the playback device is playing back audio content may cause the playback device to pause the currently playing audio content. Other examples are also possible.

In some implementations, in line with the discussion above, the region of the control strip 700 indicated by the icon 703 may be used to control more than only a play/pause state of the playback device. For example, a tap input initiated at a location in the region comprising the icon 703 may also be used to control grouping behavior of the playback device. It should be understood that in other implementations, such a multi-purpose region may be depicted by a different icon than the icon 703.

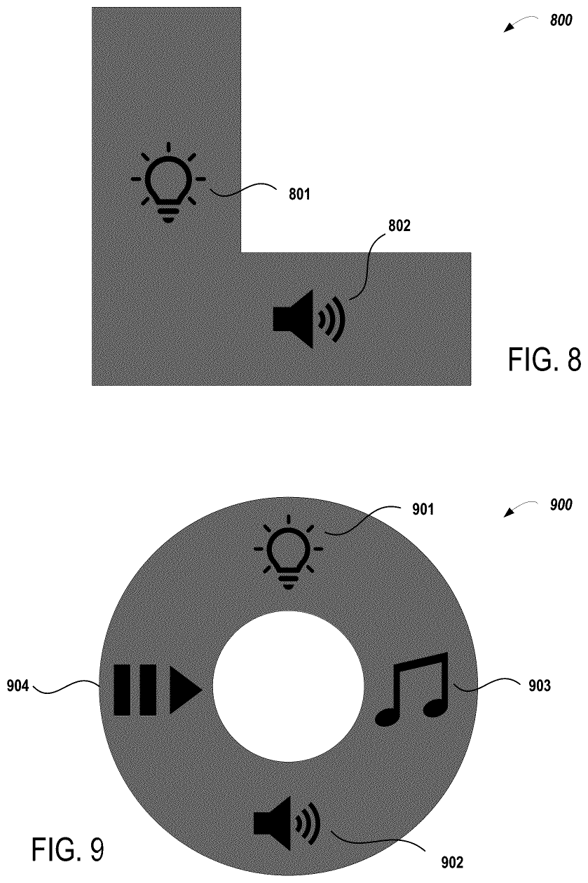

FIG. 8 depicts an example of an intelligent control interface of a multi-purpose playback device according to a fourth embodiment of the disclosed technology. In the example of FIG. 8, the control interface takes the form of an L-shaped capacitive control panel 800 that may be used to control two different settings of the playback device. In line with the discussion above, the control panel 800 may comprise two regions respectively corresponding to the two settings, which may be indicated by respective visual icons 801 and 802. The icon 801, which comprises a lightbulb icon, may indicate a first region that corresponds to a light setting of the playback device. For instance, a set of inputs initiated at a location in the first region may indicate selection of the light setting (e.g., a brightness level) of the playback device for adjustment. The icon 802, which comprises a speaker icon, may indicate a second region that corresponds to a sound setting of the playback device. For instance, a set of inputs initiated at a location the second region may indicate selection of the sound setting (e.g., a volume level) of the playback device for adjustment.

In the example of FIG. 8, the respective regions corresponding to the sound and light settings may be located at a respective leg of the L-shaped capacitive control panel 800. For instance, the first region of the control panel 800 corresponding to the light setting and indicated by the icon 801 may be located at a vertical leg of the capacitive control panel 800, such that a set of inputs initiated at a location on the vertical leg and including a drag input in a vertical direction (e.g., an upward and/or downward direction) may indicate a command to adjust the brightness level of the playback device. Similarly, the second region of the control panel 800 corresponding to the sound setting and indicated by the icon 802 may be located at a horizontal leg of the capacitive control panel 800, such that a set of inputs initiated at a location on the horizontal leg and including a drag input in a horizontal direction (e.g., a right and/or left direction) may indicate a command to adjust the volume level of the playback device. In line with the discussion above, the playback device may dynamically update a value of a setting based on the set of inputs initiated and received at a location in a given region/leg of the panel 800.

The capacitive control panel 800 may take other forms as well. For instance, in another implementation, the capacitive control panel 800 may take the form of a square-shaped capacitive control panel, where each side or corner of the squared panel may comprise a respective region corresponding to a given setting of the playback device. Other examples are also possible.

FIG. 9 depicts an example of an intelligent control interface of a multi-purpose playback device according to a fifth embodiment of the disclosed technology. In the example of FIG. 9, the control interface takes the form of a circular capacitive control wheel 900 that may be used to control four different settings of the playback device. In line with the discussion above, the control wheel 900 may comprise four regions respectively corresponding to the four settings, as indicated by respective visual icons 901, 902, 903 and 904. The icon 901, which comprises a lightbulb icon, may indicate a first region that corresponds to a light setting (e.g., a brightness level) of the playback device. For instance, a set of inputs initiated at a location in the first region and including a drag input in a clockwise and/or counter-clockwise direction along the control wheel may indicate selection and adjustment of the brightness level of the playback device for adjustment. The icon 902, which comprises a speaker icon, may indicate a second region that corresponds to a sound setting (e.g., a volume level) of the playback device. For instance, a set of inputs initiated at a location in the second region and including a drag input in a clockwise and/or counter-clockwise direction along the control wheel may indicate selection and adjustment of the volume level of the playback device for adjustment. The icon 903, which comprises a musical note icon, may indicate a third region that corresponds to a music setting (e.g., content selection) of the playback device. For instance, a set of inputs initiated at a location in the third region and including a drag input in a clockwise and/or counter-clockwise direction along the control wheel may indicate selection of a type of audio content to be played back by the playback device. The icon 904, which comprises a play/pause icon, may indicate a fourth region that corresponds to a play/pause setting (and/or one or more other playback settings in line with the discussion above) of the playback device. For instance, a set of inputs initiated at a location in the fourth region may cause the playback device to engage in a particular behavior, such as play back audio content, pause audio content, skip audio content, or join a synchrony group with one or more other playback device, among other possibilities as discussed above.

It should be understood that FIGS. 4A-9 depict only some examples of the disclosed intelligent control interface, and that other shapes and forms may also be possible without departing from the concept and scope of the control interface as disclosed herein.

For instance, the disclosed intelligent control interface may be configured to control additional settings not discussed above. For example, in one implementation, the intelligent control interface may be integrated with or otherwise communicatively coupled to a display device (e.g., a playback device comprising a display, a television device, a tablet, a smartphone, etc.). In such an implementation, the intelligent control interface may include a respective region corresponding to a video setting of the display device. For instance, as one possibility, the intelligent control interface may be used to adjust a zoom level of video content being presented at the display device. As another possibility, the intelligent control interface may be used to adjust playback of video content being presented at the display device. Other examples are also possible.

The disclosed intelligent control interface may take various other forms as well.

### IV. Example Techniques for Adjusting Playback Device Settings

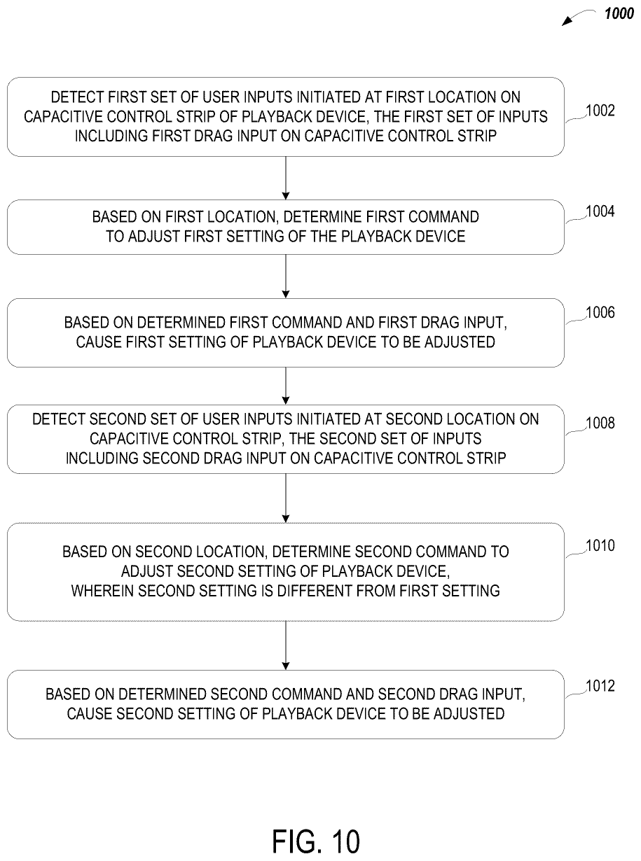

FIG. 10 depicts a flow diagram of an example process for adjusting a setting of a multi-purpose playback device using an intelligent control interface as disclosed herein.

The example process 1000 for adjusting a setting of a multi-purpose playback device may be carried out by one or more computing devices of a networked device system. For purposes of illustration, the examples discussed below with respect to the process 1000 will be described as being carried out by a multi-purpose playback device that comprises the disclosed intelligent control interface. However, it should be understood that in different implementations, one or more of the operations of the example process 1000 may be carried out by one or more other computing devices of a networked device system that includes the multi-purpose playback device. For example, in an implementation where the disclosed intelligent control interface is integrated with an illumination device, one or more of the operations of the process 1000 may be carried out by the illumination device. As another example, in an implementation where the intelligent control interface is a stand-alone control interface that may be used to control one or more networked devices, one or more of the operations of the process 1000 may be carried out by the intelligent control interface or another network-enabled device, such as a playback device or a remote computing device. Other examples are also possible.

Further, for the purposes of illustration, the intelligent control interface described below with respect to the process 1000 will be described in the context of a capacitive control strip, but it should be understood that the process 1000 may be carried out for any one or more of the various embodiments of the intelligent control interfaces contemplated herein.

The example process 1000 may begin at block 1002, where a playback device may detect a first set of user inputs (e.g., a first touch-drag-release input) initiated at a first location (e.g., a location in a first region corresponding to a first setting of the playback device) on a capacitive control strip of the playback device. In line with the discussion above, the first set of user inputs may include a first drag input, indicating an adjustment to the first setting, provided at the capacitive control strip.

At block 1004, the playback device may determine, based on the first location, a first command to adjust a first setting of the playback device. For instance, as described above, the playback device may determine that the first location is in a first region corresponding to the first setting of the playback device. For example, the playback device may determine that a volume level of the playback device is to be adjusted.

At block 1006, based on the determined first command and the first drag input (e.g., a drag in a left and/or right direction, a drag in an upward and/or downward direction, a drag in a clockwise and/or counterclockwise direction, etc.), the playback device may cause the first setting of the playback device to be adjusted. For instance, in line with the discussion above, the playback device may adjust a value of the volume level of the playback device based on the first drag input included in the first set of user inputs, such as to increase and/or decrease the volume level.

At block 1008, the playback device may detect a second set of user inputs (e.g., a second touch-drag-release input) initiated at a second location (e.g. a location in a second region corresponding to a second setting of the playback device) on the capacitive control strip of the playback device. In line with the discussion above, the second set of user inputs may include a second drag input, indicating an adjustment to the second setting, provided at the capacitive control strip.

At block 1008, the playback device may determine, based on the second location, a second command to adjust the second setting of the playback device. For instance, in line with the discussion above, the playback device may determine that the second location is in a second region corresponding to the second setting of the playback device. For example, the playback device may determine that the brightness level of the playback device is to be adjusted.

At block 1012, based on the determined second command and the second drag input (e.g., a drag in a left and/or right direction, a drag in an upward and/or downward direction, a drag in a clockwise and/or counterclockwise direction, etc.), the playback device may cause the second setting of the playback device to be adjusted. For instance, in line with the discussion above, the playback device may adjust a value of the brightness level of the playback device based on the drag input included in the second set of user inputs, such as to increase and/or decrease the brightness level.

In line with the discussion above, one or more of the operations of blocks 1002-1012 may be repeated based on the playback device detecting a set of inputs provided at the capacitive control strip.

FIG. 10 includes one or more operations, functions, or actions as illustrated by one or more of operational blocks 1002-1012. Although the blocks are illustrated in a given order, some of the blocks may also be performed in parallel, and/or in a different order than those described herein. Also, the various blocks may be combined into fewer blocks, divided into additional blocks, and/or removed based upon the desired implementation.

In addition, for the flowchart shown in FIG. 10 and other processes and methods disclosed herein, the diagrams show functionality and operation of one possible implementation of present embodiments. In this regard, each block may represent a module, a segment, or a portion of program code, which includes one or more instructions executable by one or more processors for implementing logical functions or blocks in the process.

The program code may be stored on any type of computer-readable medium, for example, such as a storage device including a disk or hard drive. The computer-readable medium may include non-transitory computer-readable medium, for example, such as computer-readable media that stores data for short periods of time like register memory, processor cache and Random Access Memory (RAM). The computer-readable medium may also include non-transitory media, such as secondary or persistent long-term storage, like read only memory (ROM), optical or magnetic disks, compact-disc read only memory (CD-ROM), for example. The computer-readable media may also be any other volatile or non-volatile storage systems. The computer-readable medium may be considered a computer-readable storage medium, for example, or a tangible storage device. In addition, for the processes and methods disclosed herein, each block in FIG. 10 may represent circuitry and/or machinery that is wired or arranged to perform the specific functions in the process.

### V. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

Further, the examples described herein may be employed in systems separate and apart from media playback systems such as any Internet of Things (IoT) system comprising an IoT device. An IoT device may be, for example, a device designed to perform one or more specific tasks (e.g., making coffee, reheating food, locking a door, providing power to another device, playing music) based on information received via a network (e.g., a WAN such as the Internet). Example IoT devices include a smart thermostat, a smart doorbell, a smart lock (e.g., a smart door lock), a smart outlet, a smart light, a smart vacuum, a smart camera, a smart television, a smart kitchen appliance (e.g., a smart oven, a smart coffee maker, a smart microwave, and a smart refrigerator), a smart home fixture (e.g., a smart faucet, a smart showerhead, smart blinds, and a smart toilet), and a smart speaker (including the network accessible and/or voice-enabled playback devices described above). These IoT systems may also comprise one or more devices that communicate with the IoT device via one or more networks such as one or more cloud servers (e.g., that communicate with the IoT device over a WAN) and/or one or more computing devices (e.g., that communicate with the IoT device over a LAN and/or a PAN). Thus, the examples described herein are not limited to media playback systems.

It should be appreciated that references to transmitting information to particular components, devices, and/or systems herein should be understood to include transmitting information (e.g., messages, requests, responses) indirectly or directly to the particular components, devices, and/or systems. Thus, the information being transmitted to the particular components, devices, and/or systems may pass through any number of intermediary components, devices, and/or systems prior to reaching its destination. For example, a control device may transmit information to a playback device by first transmitting the information to a computing system that, in turn, transmits the information to the playback device. Further, modifications may be made to the information by the intermediary components, devices, and/or systems. For example, intermediary components, devices, and/or systems may modify a portion of the information, reformat the information, and/or incorporate additional information.

Similarly, references to receiving information from particular components, devices, and/or systems herein should be understood to include receiving information (e.g., messages, requests, responses) indirectly or directly from the particular components, devices, and/or systems. Thus, the information being received from the particular components, devices, and/or systems may pass through any number of intermediary components, devices, and/or systems prior to being received. For example, a control device may receive information from a playback device indirectly by receiving information from a cloud server that originated from the playback device. Further, modifications may be made to the information by the intermediary components, devices, and/or systems. For example, intermediary components, devices, and/or systems may modify a portion of the information, reformat the information, and/or incorporate additional information.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A playback device comprising:
a capacitive control strip;
at least one processor;
non-transitory computer-readable medium; and
program instructions stored on the non-transitory computer-readable medium that are executable by the at least one processor such that the playback device is configured to:
detect a first set of user inputs initiated at a first location on the capacitive control strip, the first set of inputs including a first drag input on the capacitive control strip;
based on the first location on the capacitive control strip, determine a first command to adjust a first setting of the playback device;
based on the determined first command and the first drag input, adjust the first setting of the playback device;
detect a second set of user inputs initiated at a second location on the capacitive control strip, the second set of inputs including a second drag input on the capacitive control strip;
based on the second location on the capacitive control strip, determine a second command to adjust a second setting of the playback device, wherein the second setting is different from the first setting; and
based on the determined second command and the second drag input, adjust the second setting of the playback device.

2. The playback device of claim 1, further comprising:
an illumination device, wherein the first setting comprises a volume level of the playback device and wherein the second setting comprises a brightness level of the illumination device.

3. The playback device of claim 1, wherein the first drag input and the second drag input each comprises either or both of (i) a drag in a first direction indicating a command to increase a value of the respective first or second setting or (ii) a drag in a second direction indicating a command to decrease the value of the respective first or second setting.

4. The playback device of claim 1, wherein:
the capacitive control strip comprises a respective visual indication for each setting available for adjustment via the capacitive control strip;
the first location on the capacitive control strip comprises a first visual indication for the first setting; and
the second location on the capacitive control strip comprises a second visual indication for the second setting.

5. The playback device of claim 1, wherein the second drag input traverses at least a portion of the first location on the control strip.

6. The playback device of claim 1, wherein:
the capacitive control strip is an L-shaped capacitive control strip;
the first location is on a first leg of the capacitive control strip; and
the second location is on a second leg of the capacitive control strip.

7. The playback device of claim 1, wherein:
the capacitive control strip is a circular capacitive control strip; and
the first drag input and the second drag input each comprises either or both of (i) a drag in a clockwise direction indicating a command to increase a value of the respective first or second setting or (ii) a drag in a counter-clockwise direction indicating a command to decrease the value of the respective first or second setting.

8. The playback device of claim 1, further comprising program instructions stored on the non-transitory computer-readable medium that are executable by the at least one processor such that the playback device is configured to:
detect a third input initiated at a third location on the capacitive control strip;
based on the third location on the capacitive control strip, determine a third command to adjust playback of media content by the playback device; and
based on the determined third command, adjust the playback of media content by the playback device.

9. The playback device of claim 8, wherein the third command comprises a command to play or pause media content.

10. The playback device of claim 8, wherein the third command comprises a command to select pre-determined media content for playback.

11. A method carried out by a computing device, the method comprising:
detecting a first set of user inputs initiated at a first location on a capacitive control strip of the computing device, the first set of inputs including a first drag input on the capacitive control strip;
based on the first location on the capacitive control strip, determining a first command to adjust a first setting of the computing device;
based on the determined first command and the first drag input, adjusting the first setting of the computing device;
detecting a second set of user inputs initiated at a second location on the capacitive control strip, the second set of inputs including a second drag input on the capacitive control strip;
based on the second location on the capacitive control strip, determining a second command to adjust a second setting of the computing device, wherein the second setting is different from the first setting; and
based on the determined second command and the second drag input, adjusting the second setting of the computing device.

12. The method of claim 11, wherein the computing device comprises a playback device further comprising an illumination device, and wherein the first setting comprises a volume level of the playback device and wherein the second setting comprises a brightness level of the illumination device.

13. The method of claim 11, wherein the first drag input and the second drag input each comprises either or both of (i) a drag in a first direction indicating a command to increase a value of the respective first or second setting or (ii) a drag in a second direction indicating a command to decrease the value of the respective first or second setting.

14. The method of claim 11, wherein:
the capacitive control strip comprises a respective visual indication for each setting available for adjustment via the capacitive control strip;
the first location on the capacitive control strip comprises a first visual indication for the first setting; and
the second location on the capacitive control strip comprises a second visual indication for the second setting.

15. The method of claim 11, wherein the second drag input traverses at least a portion of the first location on the control strip.

16. The method of claim 11, wherein:
the capacitive control strip is an L-shaped capacitive control strip;
the first location is on a first leg of the capacitive control strip; and
the second location is on a second leg of the capacitive control strip.

17. The method of claim 11, wherein:
the capacitive control strip is a circular capacitive control strip; and
the first drag input and the second drag input each comprises either or both of (i) a drag in a clockwise direction indicating a command to increase a value of the respective first or second setting or (ii) a drag in a counter-clockwise direction indicating a command to decrease the value of the respective first or second setting.

18. A non-transitory computer-readable medium, wherein the non-transitory computer-readable medium is provisioned with program instructions that, when executed by at least one processor, cause a computing device to:
detect a first set of user inputs initiated at a first location on a capacitive control strip of the computing device, the first set of inputs including a first drag input on the capacitive control strip;
based on the first location on the capacitive control strip, determine a first command to adjust a first setting of the computing device;
based on the determined first command and the first drag input, adjust the first setting of the computing device;
detect a second set of user inputs initiated at a second location on the capacitive control strip, the second set of inputs including a second drag input on the capacitive control strip;
based on the second location on the capacitive control strip, determine a second command to adjust a second setting of the computing device, wherein the second setting is different from the first setting; and
based on the determined second command and the second drag input, adjust the second setting of the computing device.

19. The non-transitory computer-readable medium of claim 18, wherein the computing device comprises a playback device further comprising an illumination device.

20. The non-transitory computer-readable medium of claim 18, wherein the first drag input and the second drag input each comprises either or both of (i) a drag in a first direction indicating a command to increase a value of the respective first or second setting or (ii) a drag in a second direction indicating a command to decrease the value of the respective first or second setting.
